(19) United States
(12) Patent Application Publication
(10) Pub. No.: US 2025/0220358 A1
(43) Pub. Date: Jul. 3, 2025

(54) SOUND OUTPUT APPARATUS

(71) Applicant: LG Display Co., Ltd., Seoul (KR)

(72) Inventors: Eun ROH, Paju-si (KR); NohJin MYUNG, Paju-si (KR); SangWoo JIN, Paju-si (KR); SeungRyull PARK, Paju-si (KR)

(21) Appl. No.: 18/932,138

(22) Filed: Oct. 30, 2024

(30) Foreign Application Priority Data
Dec. 27, 2023 (KR) 10-2023-0192927

(51) Int. Cl. H04R 17/00

(52) U.S. Cl. CPC H04R 17/00

(57) ABSTRACT

A sound output apparatus can comprise a vibration member including a vibration plate, the vibration plate including a pattern part, and a vibration apparatus configured to vibrate the vibration member based on a piezoelectric effect. The pattern part comprises one or more of a plurality of holes and a plurality of grooves and is configured to increase an average sound pressure level of the sound output apparatus.

### CROSS-REFERENCE TO RELATED APPLICATIONS

This application claims the benefit of the Korean Patent Application No. 10-2023-0192927 filed on Dec. 27, 2023, which is hereby incorporated by reference as if fully set forth herein.

### BACKGROUND

### Technical Field

The present disclosure relates to a sound output apparatus, and more particularly, to a sound output apparatus for outputting a sound by vibrating a vibration member.

### Description of the Related Art

Recently, the demands for slimmer and thinner electronic devices are increasing. In speakers applied to electronic devices, piezoelectric devices capable of being implemented with a thin thickness are attracting much attention instead of voice coils, based on the demands for slimmer and thinner electronic devices.

A speaker (as a sound output apparatus) with a piezoelectric device (as a vibration apparatus) may generate (or output) sound by vibrating a vibration member according to the vibration of piezoelectric device. The sound quality and/or sound pressure characteristics of the sound generated (or outputted) according to the vibration of the vibration member may be changed by the material and structure of the vibration member. Thus, there is a need to improve or optimize the sound quality and/or sound pressure characteristics of the sound generated (or outputted) by the vibration member when driven by the piezoelectric device.

### BRIEF SUMMARY

The inventors of the present disclosure have recognized these limitations, and have conducted various studies and experiments to improve or optimize the sound quality characteristics and/or sound pressure characteristics of the sound generated (or output) depending on the material and structure of the vibration member (or a diaphragm) in the sound output apparatus.

One or more aspects of the present disclosure are directed to providing a sound output apparatus which can enhance a sound characteristic and/or a sound pressure level characteristic of a sound.

Additional features, advantages, and aspects of the present disclosure are set forth in part in the present disclosure and will also be apparent from the present disclosure or can be learned by practice of the inventive concepts provided herein. Other features, advantages, and aspects of the present disclosure can be realized and attained by the structure particularly pointed out in the present disclosure, or derivable therefrom, and claims hereof as well as the appended drawings.

To achieve these and other advantages and aspects of the present disclosure, as embodied and broadly described herein, in one or more aspects, a sound output apparatus can comprise a vibration member including a vibration plate, the vibration plate including a pattern part, and a vibration apparatus configured to vibrate the vibration member based on a piezoelectric effect. The pattern part comprises one or more of a plurality of holes and a plurality of grooves and is configured to increase an average sound pressure level of the sound output apparatus.

To achieve these and other advantages and aspects of the present disclosure, as embodied and broadly described herein, in one or more aspects, a sound apparatus can comprise a sound output apparatus as described above, a supporting member disposed to face the vibration member of the sound output apparatus, and a coupling member for connecting or coupling the supporting member to the vibration member.

A sound output apparatus according to an embodiment of the present disclosure can enhance a sound characteristic and/or a sound pressure level characteristic of a sound.

A sound output apparatus according to an embodiment of the present disclosure can include a vibration member including a pattern part and can thus enhance the flatness of a sound pressure level of the sound output apparatus.

In a sound output apparatus according to an embodiment of the present disclosure, a vibration member can include a protection member and an adhesive member, and thus, can protect a vibration plate and can improve the peak and dip of a sound pressure level curve of the sound output apparatus, thereby enhancing the sound pressure level flatness of the sound output apparatus.

It is to be understood that both the foregoing general description and the following detailed description of the present disclosure are exemplary and explanatory and are intended to provide further explanation of the disclosure as claimed.

### BRIEF DESCRIPTION OF THE SEVERAL VIEWS OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a perspective view illustrating a sound output apparatus according to an embodiment of the present disclosure;

FIG. 2 is a cross-sectional view taken along line I-I′ illustrated in FIG. 1 according to an embodiment of the present disclosure;

FIG. 3 is a perspective view illustrating a vibration member according to an embodiment of the present disclosure;

FIG. 4 is an exploded perspective view illustrating a vibration member according to another embodiment of the present disclosure;

FIG. 5 is a perspective view illustrating a vibration member according to another embodiment of the present disclosure;

FIG. 6 is a cross-sectional view taken along line II-II′ illustrated in FIG. 5 according to an embodiment of the present disclosure;

FIG. 7 is a cross-sectional view taken along line II-II′ illustrated in FIG. 5 according to another embodiment of the present disclosure;

FIG. 8 is a perspective view illustrating a vibration member according to another embodiment of the present disclosure;

FIG. 9 is a cross-sectional view taken along line III-III′ illustrated in FIG. 8 according to an embodiment of the present disclosure;

FIG. 10 is a cross-sectional view taken along line III-III′ illustrated in FIG. 8 according to another embodiment of the present disclosure;

FIG. 11 is a perspective view illustrating a vibration apparatus according to an embodiment of the present disclosure;

FIG. 12 is a cross-sectional view taken along line IV-IV′ illustrated in FIG. 11 according to an embodiment of the present disclosure;

FIG. 13 is a cross-sectional view taken along line V-V′ illustrated in FIG. 11 according to an embodiment of the present disclosure;

FIG. 14 is a perspective view illustrating a vibration layer according to another embodiment of the present disclosure;

FIG. 15 is a perspective view illustrating a vibration layer according to another embodiment of the present disclosure;

FIG. 16 is an exploded perspective view illustrating a vibration apparatus according to another embodiment of the present disclosure;

FIG. 17 is a graph showing a sound pressure level characteristic of a sound output apparatus according to an experiment example and embodiments of the present disclosure;

FIG. 18 is a graph showing a sound pressure level characteristic of a sound output apparatus according to an experiment example and an embodiment of the present disclosure;

FIG. 19 is a graph showing a sound pressure level characteristic with respect to a frequency based on a size of a vibration member according to experiment examples and embodiments of the present disclosure;

FIG. 20 is a graph showing a sound pressure level characteristic according to an experiment example and another embodiment of the present disclosure;

FIG. 21 is a graph showing an average sound pressure level and a standard deviation according to an experiment example and another embodiment of the present disclosure;

FIG. 22 is a cross-sectional view illustrating a vehicular sound apparatus according to an embodiment of the present disclosure;

FIG. 23 is an exploded perspective view of a sound output apparatus illustrated in FIG. 22, in which a vibration apparatus is omitted, according to an embodiment of the present disclosure; and

FIG. 24 is a graph showing a sound pressure level characteristic of a sound output apparatus illustrated in FIG. 22 according to an experiment example and an embodiment of the present disclosure.

### DETAILED DESCRIPTION

Reference is now made in detail to aspects of the present disclosure, examples of which can be illustrated in the accompanying drawings. In the following description, when a detailed description of well-known functions, structures or configurations can unnecessarily obscure aspects of the present disclosure, a detailed description of such known functions or configurations can have been omitted for brevity. Further, repetitive descriptions can be omitted for brevity. The progression of processing steps and/or operations described is a non-limiting example.

The sequence of steps and/or operations is not limited to that set forth herein and may be changed to occur in an order that is different from an order described herein, with the exception of steps and/or operations necessarily occurring in a particular order. In one or more examples, two operations in succession may be performed substantially concurrently, or the two operations may be performed in a reverse order or in a different order depending on a function or operation involved.

Unless stated otherwise, like reference numerals may refer to like elements throughout even when they are shown in different drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

Advantages and features of the present disclosure, and implementation methods thereof, are clarified through the aspects described with reference to the accompanying drawings. The present disclosure may, however, be embodied in different forms and should not be construed as limited to the example aspects set forth herein. Rather, these example aspects are examples and are provided so that this disclosure can be thorough and complete to assist those skilled in the art to understand the inventive concepts without limiting the protected scope of the present disclosure.

Shapes (e.g., sizes, lengths, widths, heights, thicknesses, locations, radii, diameters, and areas), dimensions, ratios, angles, numbers, and the like disclosed herein, including those illustrated in the drawings are merely examples, and thus, the present disclosure is not limited to the illustrated details. Any implementation described herein as an “example” is not necessarily to be construed as preferred or advantageous over other implementations. It is, however, noted that the relative dimensions of the components illustrated in the drawings are part of the present disclosure.

Where the term “comprise,” “have,” “include,” “contain,” “constitute,” “made of,” “formed of,” or the like is used with respect to one or more elements, one or more other elements can be added unless a term such as “only” or the like, is used. The terms used in the present disclosure are merely used in order to describe example aspects, and are not intended to limit the scope of the present disclosure. The terms of a singular form can include plural forms unless the context clearly indicates otherwise.

The word “exemplary” is used to mean serving as an example or illustration, unless otherwise specified. Aspects are example aspects. “Aspects,” “examples,” “aspects,” and the like should not be construed as preferred or advantageous over other implementations. An aspect, an example, an example aspect, an aspect, or the like may refer to one or more aspects, one or more examples, one or more example aspects, one or more aspects, or the like, unless stated otherwise. Further, the term “may” encompasses all the meanings of the term “can.”

In one or more aspects, unless explicitly stated otherwise, element, feature, or corresponding information (e.g., a level, range, dimension, size, or the like) is construed to include an error or tolerance range even where no explicit description of such an error or tolerance range is provided. An error or tolerance range can be caused by various factors (e.g., process factors, internal or external impact, noise, or the like). In interpreting a numerical value, the value is interpreted as including an error range unless explicitly stated otherwise.

In describing a positional relationship when the positional relationship between two parts (e.g., layers, films, regions, components, sections, or the like) is described, for example, using “on,” “upon,” “on top of,” “over,” “under,” “above,” “below,” “beneath,” “near,” “close to,” “adjacent to,” “beside,” “next to,” “at or on a side of,” or the like, one or more other parts can be located between the two parts unless a more limiting term, such as “immediate(ly),” “direct(ly),” or “close(ly),” is used. For example, where a structure is described as being positioned “on,” “upon,” “on top of,” “over,” “under,” “above,” “below,” “beneath,” “near,” “close to,” “adjacent to,” “beside,” “next to,” “at or on a side of,” or the like another structure, this description should be construed as including a case in which the structures contact each other as well as a case in which one or more additional structures are disposed or interposed therebetween. Furthermore, the terms “front,” “rear,” “back,” “left,” “right,” “top,” “bottom,” “downward,” “upward,” “upper,” “lower,” “up,” “down,” “column,” “row,” “vertical,” “horizontal,” and the like refer to an arbitrary frame of reference.

Spatially relative terms, such as “below,” “beneath,” “lower,” “on,” “above,” “upper” and the like, can be used to describe a correlation between various elements (e.g., layers, films, regions, components, sections, or the like) as shown in the drawings. The spatially relative terms are to be understood as terms including different orientations of the elements in use or in operation in addition to the orientation depicted in the drawings. For example, if the elements shown in the drawings are turned over, elements described as “below” or “beneath” other elements would be oriented “above” other elements. Thus, the term “below,” which is an example term, can include all directions of “above” and “below.” Likewise, an exemplary term “above” or “on” can include both directions of “above” and “below.”

In describing a temporal relationship, when the temporal order is described as, for example, “after,” “subsequent,” “next,” “before,” “preceding,” “prior to,” or the like, a case that is not consecutive or not sequential can be included and thus one or more other events may occur therebetween, unless a more limiting term, such as “just,” “immediate(ly),” or “direct(ly),” is used.

The terms, such as “below,” “lower,” “above,” “upper” and the like, may be used herein to describe a relationship between element(s) as illustrated in the drawings. It will be understood that the terms are spatially relative and based on the orientation depicted in the drawings.

It is understood that, although the terms “first,” “second,” or the like can be used herein to describe various elements (e.g., layers, films, regions, components, sections, or the like), these elements should not be limited by these terms, for example, to any particular order, sequence, precedence, or number of elements. These terms are used only to distinguish one element from another. For example, a first element could be termed a second element, and, similarly, a second element could be termed a first element, without departing from the scope of the present disclosure. Furthermore, the first element, the second element, and the like can be arbitrarily named according to the convenience of those skilled in the art without departing from the scope of the present disclosure. For clarity, the functions or structures of these elements (e.g., the first element, the second element and the like) are not limited by ordinal numbers or the names in front of the elements. Further, a first element may include one or more first elements. Similarly, a second element or the like may include one or more second elements or the like.

In describing elements of the present disclosure, the terms “first,” “second,” “A,” “B,” “(a),” “(b),” or the like can be used. These terms are intended to identify the corresponding element(s) from the other element(s), and these are not used to define the essence, basis, order, or number of the elements.

For the expression that an element (e.g., layer, film, region, component, section, or the like) is described as “connected,” “coupled,” “attached,” “adhered,” or the like to another element, the element can not only be directly connected, coupled, attached, adhered, or the like to another element, but also be indirectly connected, coupled, attached, adhered, or the like to another element with one or more intervening elements disposed or interposed between the elements, unless otherwise specified.

For the expression that an element (e.g., layer, film, region, component, section, or the like) “contacts,” “overlaps,” or the like with another element, the element can not only directly contact, overlap, or the like with another element, but also indirectly contact, overlap, or the like with another element with one or more intervening elements disposed or interposed between the elements, unless otherwise specified.

The phase that an element (e.g., layer, film, region, component, section, or the like) is “provided in,” “disposed in,” or the like in another element may be understood as that at least a portion of the element is provided in, disposed in, or the like in another element, or that the entirety of the element is provided in, disposed in, or the like in another element. The phase that an element (e.g., layer, film, region, component, section, or the like) “contacts,” “overlaps,” or the like with another element may be understood as that at least a portion of the element contacts, overlaps, or the like with a least a portion of another element, that the entirety of the element contacts, overlaps, or the like with a least a portion of another element, or that at least a portion of the element contacts, overlaps, or the like with the entirety of another element.

The terms such as a “line” or “direction” should not be interpreted only based on a geometrical relationship in which the respective lines or directions are parallel or perpendicular to each other. Such terms can mean a wider range of lines or directions within which the components of the present disclosure can operate functionally. For example, the terms “first direction,” “second direction,” and the like, such as a direction parallel or perpendicular to “x-axis,” “y-axis,” or “z-axis,” should not be interpreted only based on a geometrical relationship in which the respective directions are parallel or perpendicular to each other, and may be meant as directions having wider directivities within the range within which the components of the present disclosure can operate functionally.

The term “at least one” should be understood as including any and all combinations of one or more of the associated listed items. For example, each of the phrases of “at least one of a first item, a second item, or a third item” and “at least one of a first item, a second item, and a third item” may represent (i) a combination of items provided by two or more of the first item, the second item, and the third item or (ii) only one of the first item, the second item, or the third item.

The expression of a first element, a second elements, “and/or” a third element should be understood to encompass one of the first, second, and third elements, as well as any and all combinations of the first, second and third elements. By way of example, A, B and/or C encompass only A; only B; only C; any of A, B, and C (e.g., A, B, or C); or some combination of A, B, and C (e.g., A and B; A and C; or B and C); and all of A, B, and C. Furthermore, an expression “A/B” can be understood as A and/or B. For example, an expression “A/B” can refer to only A; only B; A or B; or A and B.

In one or more aspects, the terms “between” and “among” can be used interchangeably simply for convenience unless stated otherwise. For example, an expression “between a plurality of elements” can be understood as among a plurality of elements. In another example, an expression “among a plurality of elements” can be understood as between a plurality of elements. In one or more examples, the number of elements can be two. In one or more examples, the number of elements can be more than two. Furthermore, when an element (e.g., layer, film, region, component, sections, or the like) is referred to as being “between” at least two elements, the element may be the only element between the at least two elements, or one or more intervening elements may also be present.

In one or more aspects, the phrases “each other” and “one another” can be used interchangeably simply for convenience unless stated otherwise. For example, an expression “different from each other” can be understood as different from one another. In another example, an expression “different from one another” can be understood as different from each other. In one or more examples, the number of elements involved in the foregoing expression can be two. In one or more examples, the number of elements involved in the foregoing expression can be more than two.

In one or more aspects, the phrases “one or more among” and “one or more of” can be used interchangeably simply for convenience unless stated otherwise.

The term “or” means “inclusive or” rather than “exclusive or.” That is, unless otherwise stated or clear from the context, the expression that “x uses a or b” means any one of natural inclusive permutations. For example, “a or b” may mean “a,” “b,” or “a and b.” For example, “a, b or c” may mean “a,” “b,” “c,” “a and b,” “b and c,” “a and c,” or “a, b and c.”

Features of various aspects of the present disclosure can be partially or entirety coupled to or combined with each other, may be technically associated with each other, and can be operated, linked, or driven together in various ways. Aspects of the present disclosure can be implemented or carried out independently of each other, or can be implemented or carried out together in a co-dependent or related relationship. In one or more aspects, the components of each apparatus according to various aspects of the present disclosure can be operatively coupled and configured.

Unless otherwise defined, the terms (including technical and scientific terms) used herein have the same meaning as commonly understood by one of ordinary skill in the art to which example aspects belong. It should be further understood that terms, such as those defined in commonly used dictionaries, should be interpreted as having a meaning that is, for example, consistent with their meaning in the context of the relevant art and should not be interpreted in an idealized or overly formal sense, unless expressly defined otherwise herein.

The terms used herein have been selected as being general in the related technical field; however, there may be other terms depending on the development and/or change of technology, convention, preference of technicians, and so on. Therefore, the terms used herein should not be understood as limiting technical ideas, but should be understood as examples of the terms for describing example aspects.

Further, in a specific case, a term may be arbitrarily selected by an applicant, and in this case, the detailed meaning thereof is described herein. Therefore, the terms used herein should be understood based on not only the name of the terms, but also the meaning of the terms and the content hereof.

In the following description, various example aspects of the present disclosure are described in detail with reference to the accompanying drawings. With respect to reference numerals to elements of each of the drawings, the same elements can be illustrated in other drawings, and like reference numerals can refer to like elements unless stated otherwise. The same or similar elements may be denoted by the same reference numerals even though they are depicted in different drawings. In addition, for convenience of description, a scale, dimension, size, and thickness of each of the elements illustrated in the accompanying drawings can be different from an actual scale, dimension, size, and thickness. Thus, aspects of the present disclosure are not limited to a scale, dimension, size, or thickness illustrated in the drawings.

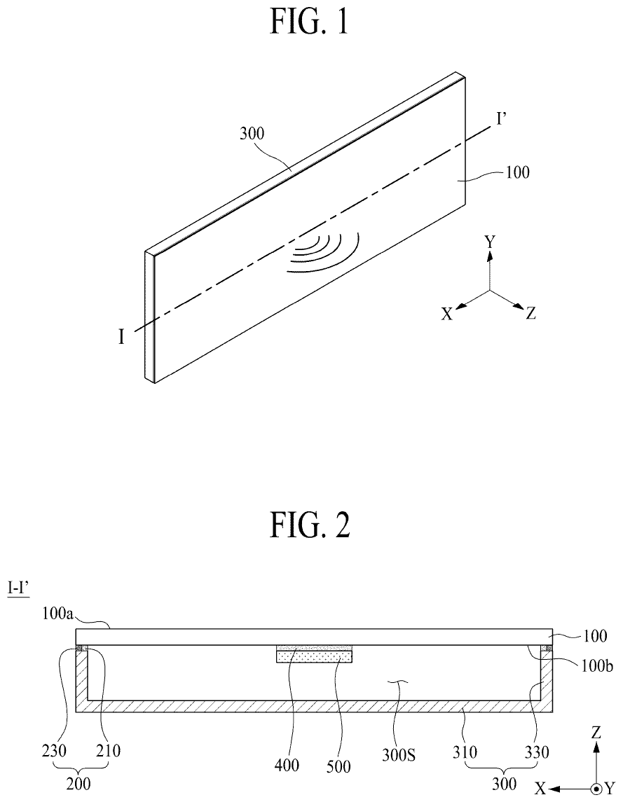

FIG. 1 is a perspective view illustrating a sound output apparatus according to an embodiment of the present disclosure. FIG. 2 is a cross-sectional view taken along line I-I′ illustrated in FIG. 1 according to an embodiment of the present disclosure.

Referring to FIGS. 1 and 2, a sound output apparatus according to an embodiment of the present disclosure can be implemented as or realized as at least one of a sound bar, a sound system, a sound apparatus for electronic apparatuses, a sound apparatus for displays, a sound apparatus for vehicular apparatuses (or transporting apparatuses), or a sound bar for vehicular apparatuses (or transporting apparatuses), or the like. For example, the vehicular apparatus (or transporting apparatus) can include a vehicle, a train, a ship, or an aircraft, but embodiments of the present disclosure are not limited thereto. Further, the sound output apparatus according to an embodiment of the present disclosure can be implemented as or realized as an analog signage or a digital signage, or the like such as an advertising signboard, a poster, or a noticeboard, or the like.

The sound output apparatus according to an embodiment of the present disclosure can include a vibration member 100 and a vibration apparatus 500.

The vibration member 100 can generate a vibration or can output a sound (or a sound wave), based on a displacement (or driving) of the vibration apparatus 500. The vibration member 100 can be a vibration object, a signage panel, a passive vibration plate, a front member, a vibration panel, a sound panel, a passive vibration panel, a sound output plate, a sound vibration plate, or the like, but embodiments of the present disclosure are not limited thereto. More generally, the vibration member 100 can be a member which is capable of vibrating when driven.

The vibration member 100 according to an embodiment of the present disclosure can include a polygonal shape including a rectangular shape or a square shape, but embodiments of the present disclosure are not limited thereto. The vibration member 100 can include a widthwise length parallel to a first direction X (e.g., X-direction shown in FIGS. 1 and 2) and a lengthwise length parallel to a second direction Y (e.g., Y-direction shown in FIGS. 1 and 2). For example, with respect to a same plane, the first direction X can be a first horizontal direction or a first horizontal length direction of the vibration member 100, and the second direction Y can be a second horizontal direction or a second horizontal length direction of the vibration member 100 which is orthogonal or substantially orthogonal to the first direction X. The vibration member 100 can also include a height or thickness in a third direction Z that is perpendicular to both the first direction X and the second direction Y. The third direction Z can be a vertical direction.

The vibration member 100 according to an embodiment of the present disclosure can include an entire structure having (e.g., substantially) a same thickness (e.g., uniform thickness), but embodiments of the present disclosure are not limited thereto. For example, the vibration member 100 can include a plate structure having (e.g., substantially) a same thickness throughout its structure (e.g., uniform thickness), but embodiments of the present disclosure are not limited thereto. For example, the vibration member 100 can include a nonplanar structure having a convex portion and/or a concave portion. For example, the vibration member 100 according to an embodiment of the present specification can be configured to have different thicknesses at the edge portion and at the center portion excluding the edge portion.

According to an embodiment of the present disclosure, the vibration member 100 can include a first surface 100a and a second surface 100b. The first surface 100a of the vibration member 100 can be a front surface, a forward surface, a top surface, or an upper surface. The second surface 100b can be a rear surface, a rearward surface, a backside, a back surface, a bottom surface, or a lower surface.

According to an embodiment of the present disclosure, the vibration member 100 can be implemented as or realized as a signage panel such as an analog signage, a digital signage, or the like such as an advertising signboard, a poster, a noticeboard, or the like. For example, when the vibration member 100 can be implemented as the signage panel, the analog signage can include signage content such as a sentence, a picture, and a sign, or the like. The signage content can be disposed at the vibration member 100 to be visible or visual. For example, the signage content can be attached on one or more regions of the first surface 100a of the vibration member 100. For example, the signage content can be directly attached on one or more regions of the first surface 100a of the vibration member 100. For example, the signage content can be printed on a medium such as paper or the like, and the medium with the signage content printed thereon can be directly attached on one or more regions of the first surface 100a of the vibration member 100. For example, when the signage content is attached on the first surface 100a of the vibration member 100, the vibration member 100 can be configured as a transparent material.

The vibration member 100 according to an embodiment of the present disclosure can include two or more materials. The vibration member 100 can include a multi-layer structure including different materials. For example, the vibration member 100 can include two or more portions including two or more different materials. The vibration member 100 can include a center portion and an outer portion, which include different materials. For example, the vibration member 100 can be configured to have a core shell structure. For example, the vibration member 100 can be configured in the core shell structure including different materials.

The vibration apparatus 500 can be configured to vibrate the vibration member 100. The vibration apparatus 500 can be disposed or configured on the vibration member 100. The vibration apparatus 500 can be configured to vibrate (or displace or drive) the vibration member 100 according to an applied driving signal (or electric signal or voice signal). For example, the vibration apparatus 500 can be an active vibration panel, a vibration generator, a vibration structure, a vibrator, a vibration generating device, a sound generator, an acoustic device, a sound generating structure, or a sound generating element, but embodiments of the present disclosure are not limited thereto.

The vibration apparatus 500 according to an embodiment of the present disclosure can include a piezoelectric material or an electroactive material, which has a piezoelectric characteristic. The vibration apparatus 500 can autonomously vibrate (or displace or drive) based on a vibration (or displacement or driving) of the piezoelectric material based on a driving signal applied to the piezoelectric material, or can vibrate (or displace or drive) the vibration member 100 or the like. For example, the vibration apparatus 500 can alternately repeat contraction and/or expansion based on a piezoelectric effect (or a piezoelectric characteristic) to vibrate (or displace or drive). For example, the vibration apparatus 500 can vibrate (or displace or drive) in the third direction Z (e.g., a vertical direction or a thickness direction) as contraction and/or expansion are alternately repeated by an inverse piezoelectric effect.

The vibration apparatus 500 according to an embodiment of the present disclosure can include a tetragonal shape which has a first length parallel to the first direction X and a second length parallel to the second direction Y. For example, the vibration apparatus 500 can include a square shape where the first length is the same as the second length, but embodiments of the present disclosure are not limited thereto. The vibration apparatus 500 can have a relatively smaller size (or area) than the vibration member 100.

The sound output apparatus according to an embodiment of the present disclosure can further include a connection member 400.

The connection member 400 can be disposed or connected between the vibration apparatus 500 and the vibration member 100. The connection member 400 can be disposed between the vibration apparatus 500 and the vibration member 100, and can connect or couple the vibration apparatus 500 to the vibration member 100. For example, the vibration apparatus 500 can be connected or coupled to the vibration member 100 by the connection member 400. For example, the vibration apparatus 500 can be connected to or supported by the second surface 100b of the vibration member 100 by the connection member 400, but embodiments of the present disclosure are not limited thereto.

The connection member 400 according to an embodiment of the present disclosure can include an adhesive layer (or a tacky layer) which is suitable in providing an attaching force or adhesive force. For example, the connection member 400 can be configured as a material including an adhesive layer which is suitable in providing the attaching force or adhesive force, with respect to each of the vibration apparatus 500 and the second surface 100b of the vibration member 100. For example, the connection member 400 can include a foam pad, a double-sided tape, a double-sided foam pad, a double-sided foam tape, an adhesive, a double-sided adhesive, a double-sided adhesive tape, a double-sided adhesive foam pad, a tacky sheet, or the like, but embodiments of the present disclosure are not limited thereto. For example, when the connection member 400 includes the tacky sheet (or an adhesive layer), the connection member 400 can include only an adhesive layer or a tacky layer without a base member such as a plastic material or the like.

An adhesive layer of the connection member 400 according to an embodiment of the present disclosure can include a pressure sensitive adhesive (PSA), an optically cleared adhesive (OCA), an optically cleared resin (OCR), epoxy resin, acrylic resin, silicone resin, or urethane resin, or the like, but embodiments of the present disclosure are not limited thereto. For example, the adhesive layer of the connection member 400 can include an acrylic-based substance (or material) having a characteristic where an adhesive force is relatively better, and hardness is higher. Accordingly, the transfer efficiency of the vibration force (or displacement force) that is transferred from the vibration apparatus 500 to the vibration member 100 can be increased.

The sound output apparatus according to an embodiment of the present disclosure can further include a supporting member 300.

The supporting member 300 can be configured or disposed at a rear surface of the vibration member 100. The supporting member 300 can be configured or disposed at the second surface 100b of the vibration member 100. The supporting member 300 can be configured to support a periphery portion of the second surface 100b of the vibration member 100. The supporting member 300 can be configured to support a periphery portion of a rear surface of the vibration member 100. The supporting member 300 can be configured to cover the vibration apparatus 500 and the second surface 100b of the vibration member 100.

The supporting member 300 according to an embodiment of the present disclosure can include an internal space 300S which surrounds the second surface 100b of the vibration member 100. For example, the supporting member 300 can include a box shape where one side (or one portion or an upper side or an upper portion) of the internal space 300S is opened. For example, the supporting member 300 can be a case, an outer case, a case member, a housing, a housing member, a cabinet, an enclosure, a sealing member, a sealing cap, a sealing box, a sound box, an accommodation member, a receiving member, or the like, but embodiments of the present disclosure are not limited thereto. For example, the internal space 300S of the supporting member 300 can be an accommodation space, a receiving space, a gap space, an air space, a vibration space, a sound space, a sound box, a sealing space, a resonance space, or the like, but embodiments of the present disclosure are not limited thereto.

The supporting member 300 according to an embodiment of the present disclosure can include one or more of a metal material and a nonmetal material (or a composite nonmetal material), but embodiments of the present disclosure are not limited thereto. For example, the supporting member 300 can include one or more materials of a metal material, plastic, and wood, but embodiments of the present disclosure are not limited thereto.

The supporting member 300 according to an embodiment of the present disclosure can include a first supporting part 310 and a second supporting part 330.

The first supporting part 310 can be disposed in parallel with the vibration member 100. The first supporting part 310 can be disposed to face the second surface 100b of the vibration member 100. The first supporting part 310 can be disposed to cover the vibration apparatus 500 and the second surface 100b of the vibration member 100. The first supporting part 310 can be spaced apart from the vibration apparatus 500 and the second surface 100b of the vibration member 100. For example, the first supporting part 310 can be spaced apart from the second surface 100b of the vibration member 100 with the internal space 300S therebetween. For example, the first supporting part 310 can be a bottom part, a bottom plate, a supporting plate, a housing plate, a housing bottom part, or the like, but embodiments of the present disclosure are not limited thereto.

The second supporting part 330 can be configured or disposed at a periphery portion of the vibration member 100. The second supporting part 330 can be connected to a periphery portion of the first supporting part 310. For example, the second supporting part 330 can include a structure bent from the periphery portion of the first supporting part 310. For example, the second supporting part 330 can be parallel to a third direction Z (e.g., Z-direction as shown in FIGS. 1 and 2), or can be inclined from the third direction Z. For example, the supporting member 300 can include two or more second supporting parts 330. For example, the second supporting part 330 can be a lateral part, a sidewall, a supporting sidewall, a housing lateral surface, a housing sidewall, or the like, but embodiments of the present disclosure are not limited thereto.

The second supporting part 330 can be integrated with the first supporting part 310. For example, the first supporting part 310 and the second supporting part 330 can be integrated (or configured) as one body (a single body), and thus, the internal space 300S surrounded by the second supporting part 330 can be provided over the first supporting part 310. Accordingly, the supporting member 300 can include a box shape where one side (or one portion or an upper side or an upper portion) of the internal space is opened by the first supporting part 310 and the second supporting part 330.

The supporting member 300 can be connected or coupled to the vibration member 100 by a coupling member 200. The supporting member 300 can be connected or coupled to the second surface 100b of the vibration member 100 by the coupling member 200. For example, the supporting member 300 can be connected or coupled to a periphery portion of the second surface 100b of the vibration member 100 by the coupling member 200. For example, the second supporting part 330 can be connected or coupled to the vibration member 100 by the coupling member 200. For example, the second supporting part 330 can be connected or coupled to the second surface 100b of the vibration member 100 by the coupling member 200. For example, the second supporting part 330 can be connected or coupled to a periphery portion of the second surface 100b of the vibration member 100 by the coupling member 200.

The coupling member 200 can be configured to minimize or prevent the transfer of a vibration of the vibration member 100 to the supporting member 300. The coupling member 200 can include a material characteristic suitable for blocking a vibration. For example, the coupling member 200 can include a material having elasticity. For example, the coupling member 200 can include a material having elasticity for vibration absorption (or impact absorption). The coupling member 200 according to an embodiment of the present disclosure can be configured as (or comprise) polyurethane materials and/or polyolefin materials, but embodiments of the present disclosure are not limited thereto. For example, the coupling member 200 can include one or more of an adhesive, a double-sided adhesive, a double-sided tape, a double-sided foam tape, a double-sided foam pad, and a double-sided cushion tape, but embodiments of the present disclosure are not limited thereto.

The coupling member 200 according to an embodiment of the present disclosure can prevent a physical contact (or friction) between the vibration member 100 and the second supporting part 330 of the supporting member 300, and thus, can prevent the occurrence of noise (or a noise sound) which can be caused by the physical contact (or friction) between the vibration member 100 and the supporting member 300. For example, the coupling member 200 can be a buffer member, an elastic member, a damping member, a vibration absorption member, a vibration prevention member, or a vibration blocking member, but embodiments of the present disclosure are not limited thereto.

The coupling member 200 according to another embodiment of the present disclosure can be configured to minimize or prevent the transfer of a vibration of the vibration member 100 to the supporting member 300 and to decrease the reflection of an incident sound wave which can be generated based on a vibration of the vibration member 100.

The coupling member 200 according to another embodiment of the present disclosure can include a first coupling member 210 and a second coupling member 230.

The first coupling member 210 can be disposed at a region between the vibration member 100 and the supporting member 300. The first coupling member 210 can be disposed at a region between the vibration member 100 and the second supporting part 330 of the supporting member 300. The first coupling member 210 can be disposed or coupled between a rear periphery portion of the vibration member 100 and a second supporting part 330. For example, the first coupling member 210 can be disposed inward (or towards an inner portion of the apparatus) from the second coupling member 230. The first coupling member 210 can be configured to have a hardness which is smaller than that of the second coupling member 230, for example, a modulus (of elasticity) or a Young's modulus (or elastic moduli). For example, the first coupling member 210 can include a double-sided polyurethane tape, a double-sided polyurethane foam tape, a double-sided sponge tape, or the like, but embodiments of the present disclosure are not limited thereto.

The second coupling member 230 can be disposed at a region between the vibration member 100 and the supporting member 300. For example, the second coupling member 230 can be disposed at a region between the vibration member 100 and the supporting member 300 to surround the first coupling member 210. The second coupling member 230 can be disposed or coupled between the rear periphery portion of the vibration member 100 and the second supporting part 330 of the supporting member 300. For example, the second coupling member 230 can be disposed or coupled between the rear periphery portion of the vibration member 100 and the second supporting part 330 of the supporting member 300 to surround the first coupling member 210. For example, the second coupling member 230 can be disposed outward (or towards an outer portion of the sound output apparatus) from the first coupling member 210. The second coupling member 230 can be configured to have a hardness which is greater than that of the first coupling member 210, for example, a modulus (of elasticity) or a Young's modulus (or elastic moduli). For example, the second coupling member 230 can include a double-sided polyolefin tape, a double-sided polyolefin foam tape, a double-sided acrylic tape, a double-sided acrylic foam tape, or the like, but embodiments of the present disclosure are not limited thereto.

The first coupling member 210 which is relatively soft and is disposed inward from the second coupling member 230 which is relatively stiff (or harder) can absorb an incident sound wave which can be generated based on a vibration of the vibration member 100. Thus, a sound (or a wave) generated by being reflected from the coupling member 200 can be minimized or dampened. Accordingly, flatness of a sound pressure level generated based on a vibration of the vibration member 100 can be reduced. For example, the flatness of the sound pressure level can be a level of a deviation between a highest sound pressure level and a lowest sound pressure level within a pitched sound band generated based on a vibration of the vibration member 100.

In the coupling member 200 according to another embodiment of the present disclosure, the second coupling member 230 which is relatively stiff can be disposed inward (or towards an inner portion of the sound output apparatus) from the first coupling member 210 which is relatively soft (or softer than the second coupling member 230). Accordingly, a sound pressure level in a specific-pitched sound band of a sound can be reduced. For example, a sound pressure level in a sound band of 2 kHz to 5 kHz and 7 kHz to 12 kHz can be reduced due to a reflected sound (or a reflected wave or a standing wave) generated by being reflected from the second coupling member 230 which is relatively stiff. Therefore, when a reduction in a sound pressure level in a sound band of 2 kHz to 5 kHz and 7 kHz to 12 kHz is needed based on a shape and a size of the vibration member 100, the second coupling member 230 which is relatively stiff can be disposed inward from the first coupling member 210 which is relatively soft. As such, the flatness of the sound pressure level can be improved based on a reduction in a sound pressure level in a sound band of 2 kHz to 5 kHz and 7 kHz to 12 kHz generated by the second coupling member 230.

Although it is described that the supporting member 300 is a part of the sound output apparatus, the present disclosure is not limited thereto, and the supporting member can be a separate member, e.g., a vehicular interior material which can include all parts configuring the inside of a vehicle, or can include all parts disposed at an internal space of the vehicle, which will be described below.

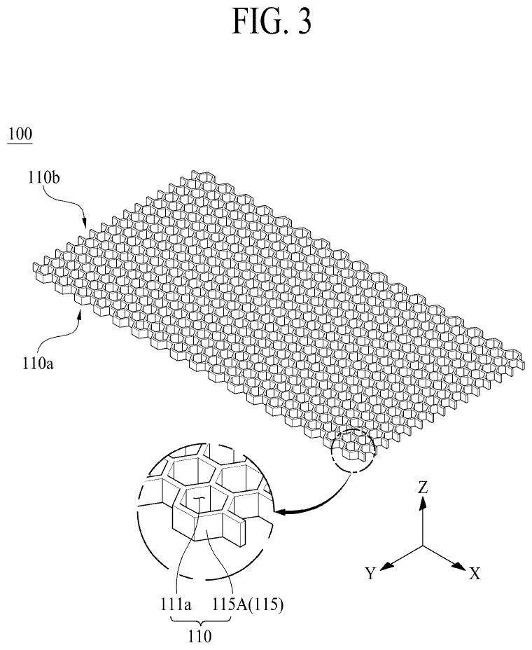

FIG. 3 is a perspective view illustrating a vibration member according to an embodiment of the present disclosure. FIG. 3 is a perspective view illustrating the vibration member illustrated in FIG. 2 according to an embodiment of the present disclosure.

Referring to FIGS. 2 and 3, the vibration member 100 according to an embodiment of the present disclosure can include a vibration plate 110. The vibration plate 110 can include a pattern part 115. The pattern part 115 can be configured at a front surface of the vibration plate 110. For example, the pattern part 115 can include a first pattern part 115A configured at the front surface of the vibration plate 110. Alternatively, the pattern part 115 can be configured at a rear surface of the vibration plate 110 or through the vibration plate 110. The first pattern part 115A can be a three-dimensional (3D) pattern having a honeycomb structure. For example, the first pattern part 115A can have a certain thickness. For example, the first pattern part 115A can include a plurality of holes 111a arranged in parallel. For example, the vibration plate 110 can have a honeycomb structure, based on the plurality of holes 111a. For example, each of the plurality of holes 111a can have a hexagonal shape. For example, each of the plurality of holes 111a can be an empty space which is hollow. Although each of the plurality of holes 111a is a through hole as shown in FIG. 3, it can be a blind hole disposed at any surface of the vibration plate 110.

According to an embodiment of the present disclosure, the vibration plate 110 can include a first surface 110a and a second surface 110b. The vibration apparatus 500 can be coupled to the first surface 110a of the vibration plate 110. The vibration plate 110 can include a metal material including aluminum (Al). For example, the vibration plate 110 can include a metal material and a plastic material. For example, a metal material of the vibration plate 110 can include one or more materials such as stainless steel, aluminum (Al), aluminum (Al) alloy, magnesium (Mg), magnesium (Mg) alloy, copper (Cu) alloy, magnesium lithium (Mg—Li) alloy, or the like, but embodiments of the present disclosure are not limited thereto. For example, the vibration plate 110 can be configured in or comprise a plastic material such as plastic or styrene material, but embodiments of the present disclosure are not limited thereto. For example, a plastic material of the vibration plate 110 can include polycarbonate, polyethylene terephthalate, polyarylate, polyethylene naphthalate, polysulfone, polyethersulfone, cyclo-olefin copolymer, or the like, but embodiments of the present disclosure are not limited thereto. For example, the styrene material can be an ABS material. The ABS material can be acrylonitrile, butadiene, and styrene. For example, the vibration plate 110 can be manufactured by using a laser process, a chemical etching process, or a computer numerical control (CNC) process. For example, a diameter, a shape, and a size of each of the plurality of holes 111a can be variously set based on the stiffness and density of the vibration plate 110.

According to an embodiment of the present disclosure, the vibration member 100 can include the vibration plate 110 where the pattern part 115 is provided, and thus, can enhance flexibility in a first direction (or an X-axis direction) and a second direction (or a Y-axis direction) and can enhance elasticity in a third direction (or a Z-axis direction). Accordingly, the sound output apparatus according to an embodiment of the present disclosure can increase in vibration width (or displacement width) of the vibration member 100 and can be enhanced in sound quality characteristic and/or sound pressure level characteristic of the sound output apparatus. Also, the vibration plate 110 can include the first pattern part 115A where the plurality of holes 111a are configured, and thus, can reduce a weight of the vibration member 110.

As another example, each of the plurality of holes 111a can be filled by resin or accommodates the resin. For example, the resin can be filled in each of the plurality of holes 111a. For example, the resin can include epoxy resin, acrylic resin, silicone resin, polycarbonate resin, or urethane resin, but embodiments of the present disclosure are not limited thereto. For example, in a case where the resin is filled in each of the plurality of holes 111a, the vibration apparatus 500 and the vibration member 100 can be connected to each other without a separate connection member 400 by using a process of curing the resin. For example, in a case where the resin is filled in each of the plurality of holes 111a, a configuration of the connection member 400 which is disposed between the vibration apparatus 500 and the vibration member 100 to connect the vibration apparatus 500 to the vibration member 100 can be omitted. However, embodiments of the present disclosure are not limited thereto.

As another example, the pattern part 115 can be configured in a partial region of the vibration plate 110. For example, the pattern part 115 can be configured in a portion of a center region of the vibration plate 110. For example, the pattern part 115 can be configured in the other region, except an edge, of the vibration plate 110. For example, the pattern part 115 can be configured in a periphery region of a partial region and/or a partial region of the vibration plate 110 overlapping the vibration apparatus 500.

According to an embodiment of the present disclosure, because the sound output apparatus includes the vibration member 100 including the pattern part 115, a vibration width (or displacement width or driving width) of the vibration member 100 can increase, and the sound quality characteristic and/or sound pressure level characteristic of the sound apparatus can be enhanced.

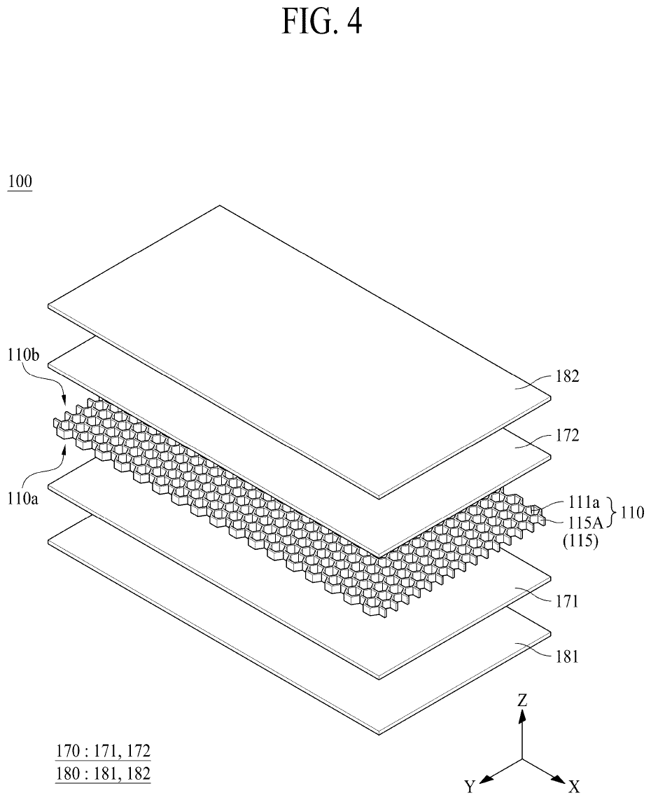

FIG. 4 is an exploded perspective view illustrating a vibration member according to another embodiment of the present disclosure. FIG. 4 is an exploded perspective view illustrating the vibration member illustrated in FIG. 2 according to another embodiment of the present disclosure. Except for that a protection member and an adhesive member are additionally configured, another embodiment of the present disclosure shown in FIG. 4 can be substantially the same as an embodiment of the present disclosure. Hereinafter, therefore, only different elements will be described.

Referring to FIGS. 2 to 4, the vibration member 100 according to another embodiment of the present disclosure can include a vibration plate 110, a protection member 180, and an adhesive member 170. The vibration plate 110 according to another embodiment of the present disclosure shown in FIG. 4 can be configured to be substantially equal to an embodiment of the present disclosure described above with reference to FIG. 3.

According to another embodiment of the present disclosure, the protection member 180 can include a first protection member 181 and a second protection member 182.

The first protection member 181 can be configured at a first surface 110a of the vibration plate 110. The first protection member 181 can be adhered to the first surface 110a of the vibration plate 110 by using a first adhesive member 171. The first protection member 181 can be configured to cover the pattern part 115 of the vibration plate 110. The first protection member 181 can protect the first surface 110a of the vibration plate 110. The first protection member 181 can protect the pattern part 115 of the vibration plate 110.

The second protection member 182 can be configured at a second surface 110b, opposite to the first surface 110a, of the vibration plate 110. The second protection member 182 can be adhered to the second surface 110b of the vibration plate 110 by using a second adhesive member 172. The second protection member 182 can be configured to cover the pattern part 115 of the vibration plate 110. The second protection member 182 can protect the second surface 110b of the vibration plate 110. The second protection member 182 can protect the pattern part 115 of the vibration plate 110.

The first protection member 181 and the second protection member 182 can include a material which is the same as or different from each other. For example, the first protection member 181 and the second protection member 182 can include one of polyimide, polyethylene terephthalate, polypropene, polyethylene, and thermoplastic polyurethane (TPU), but embodiments of the present disclosure are not limited thereto.

According to another embodiment of the present disclosure, the adhesive member 170 can include a first adhesive member 171 and a second adhesive member 172.

The first adhesive member 171 can be configured between the first surface 110a of the vibration plate 110 and the first protection member 181. The first adhesive member 171 can connect or attach the first surface 110a of the vibration plate 110 to the first protection member 181.

The second adhesive member 172 can be configured between the second surface 110b of the vibration plate 110 and the second protection member 182. The second adhesive member 172 can connect or attach the second surface 110b of the vibration plate 110 to the second protection member 182.

For example, the adhesive member 170 can include a foam pad, a double-sided tape, a double-sided foam pad, a double-sided foam tape, an adhesive, a double-sided adhesive, a double-sided adhesive tape, a double-sided adhesive foam pad, or an adhesive sheet, but embodiments of the present disclosure are not limited thereto. For example, when the adhesive member 170 includes an adhesive sheet (or an adhesive layer), the adhesive member 170 can include only an adhesive layer or a tacky layer without a base member such as a plastic material. For example, the adhesive layer of the adhesive member 170 can include an adhesive material such as pressure sensitive adhesive (PSA), optically cleared adhesive (OCA), optically cleared resin (OCR), epoxy resin, acrylic resin, silicone resin, or urethane resin, but embodiments of the present disclosure are not limited thereto. For example, in a case where resin is filled in each of the plurality of holes 111a according to an embodiment of the present disclosure, the adhesive member 170 can include the same material as resin, but embodiments of the present disclosure are not limited thereto.

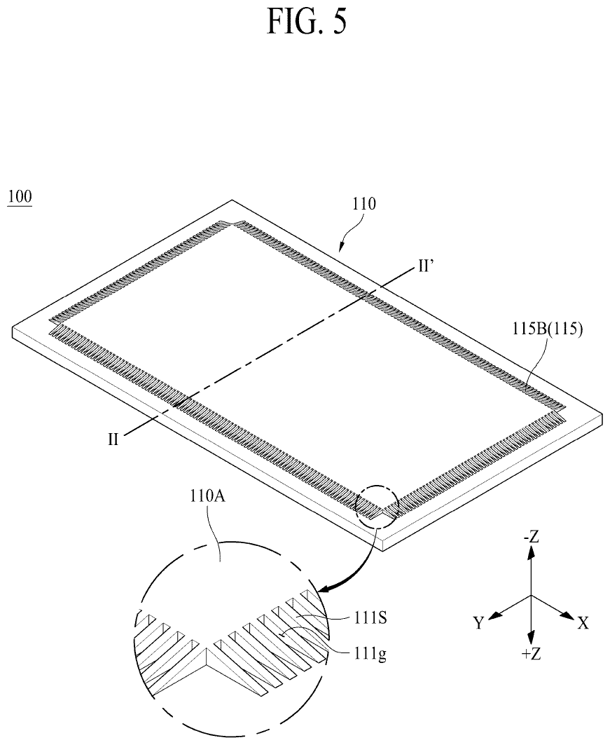

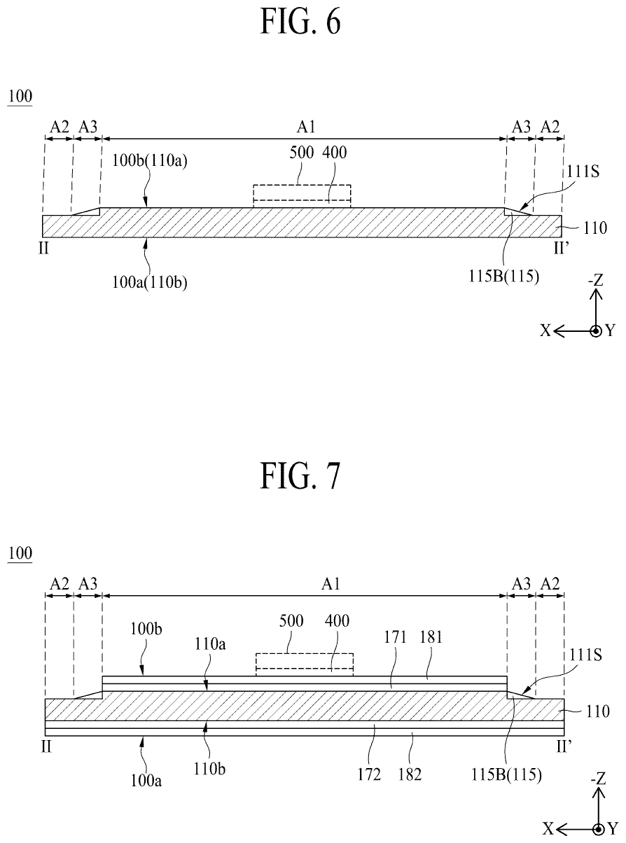

FIG. 5 is a perspective view illustrating a vibration member according to another embodiment of the present disclosure. FIG. 6 is a cross-sectional view taken along line II-II′ illustrated in FIG. 5 according to an embodiment of the present disclosure.

Referring to FIGS. 5 and 6, a vibration member 100 according to another embodiment of the present disclosure can include a vibration plate 110. For example, the vibration plate 110 can include a first region A1, a second region A2, and a third region A3.

The first region A1 can be configured at a center or a middle of the vibration plate 110. The vibration apparatus 500 can be connected to the first region A1 of the vibration plate 110. For example, the first region A1 can have a plate shape having a uniform thickness. The first region A1 can be a center region or a middle region of the vibration plate 100. For example, the first region A1 can include a protrusion portion 110A which more protrudes than the second region A2 and the third region A3. Based on the protrusion portion 110A, a thickness of the first region A1 can be thicker than that of each of the second region A2 and the third region A3. FIG. 6 only shows the protrusion portion 110A protrudes at the first surface 110a of the vibration plate 110, but the present disclosure is not limited thereto, and the protrusion portion 110A may protrude at the second surface 110b or at both surfaces of the vibration plate 110.

The second region A2 can surround the first region A1. The second region A2 can be spaced apart from the first region A1 by a certain distance. For example, the second region A2 can be an outermost region or an outermost edge region of the vibration plate 110. For example, based on the protrusion portion 110A configured in the first region A1, the second region A2 can have a thickness which differs from that of the first region A1. For example, a thickness of the second region A2 can be thinner than that of the first region A1. For example, the second region A2 can have a thickness within a range of 30% to 35% of that of the first region A1, but embodiments of the present disclosure are not limited thereto. For example, when a thickness of the second region A2 is 1 mm, a thickness of the first region A1 can be 3 mm, but embodiments of the present disclosure are not limited thereto.

The third region A3 can be configured between the first region A1 and the second region A2. The third region A3 can connect the first region A1 to the second region A2. The third region A3 can be configured at a perimeter of the first region A1. The third region A3 can be configured to surround the first region A1. For example, the third region A3 can be an outer region, an outer edge region, or an outer border region of the first region A1. For example, the third region A3 can be configured inward from the second region A2. For example, the third region A3 can be an inner region or an inner border region of the second region A2. A thickness of the third region A3 can be thinner than that of the first region A1. For example, the third region A3 can have a thickness within a range of 30% to 35% of that of the first region A1, but embodiments of the present disclosure are not limited thereto. For example, when a thickness of the third region A3 is 1 mm, a thickness of the first region A1 can be 3 mm, but embodiments of the present disclosure are not limited thereto. For example, a thickness of the third region A3 can be the same as that of the second region A2. However, embodiments of the present disclosure are not limited thereto.

The vibration plate 110 according to another embodiment of the present disclosure can include a pattern part 115. The pattern part 115 can be configured at a first surface 110a of the vibration plate 110. The pattern part 115 can be configured at the first surface 110a of the vibration plate 110 connected to the vibration apparatus 500. Alternatively, the pattern part 115 can be configured at a second surface 110b of the vibration plate 110, which is opposite to the first surface 110a, or the pattern part 115 can be configured at both the first and second surfaces 110a, 110b. The pattern part 115 can be configured in a partial region of the vibration plate 110. For example, the pattern part 115 can be configured in the third region A3 of the vibration plate 110. The pattern part 115 can be configured between the first region A1 and the second region A2 of the vibration plate 110.

According to another embodiment of the present disclosure, the pattern part 115 can include a plurality of grooves 111g. The pattern part 115 can include a plurality of protrusion patterns 111S which protrudes from a lateral surface of the protrusion portion 110A to the third region A3. The pattern part 115 can include a second pattern part 115B. The second pattern part 115B can include a plurality of protrusion patterns 111S which protrudes from the lateral surface of the protrusion portion 110A to the third region A3. For example, each of the plurality of grooves 111g can be configured between the plurality of protrusion patterns 111S. For example, each of the plurality of grooves 111g can be an empty space or filled by resin. For example, a height of each of the plurality of protrusion patterns 111S can decrease toward the second region A2 from the first region A1. For example, the plurality of protrusion patterns 111S of the second pattern part 115B can include a plurality of three-dimensional (3D) patterns. Accordingly, a plurality of protrusion patterns including a plurality of 3D patterns can be configured at a portion where a division vibration is generated, and thus, a sound quality characteristic and/or a sound characteristic of a sound output apparatus can be more enhanced. The plurality of protrusion patterns 111S can be disposed apart from one another by a certain distance. Each of the plurality of protrusion patterns 111S can include a cross-sectional surface having a triangular shape. However, embodiments of the present are not limited thereto.

According to another embodiment of the present disclosure, the vibration plate 110 can include a plastic material. For example, the vibration plate 110 can include polypropylene, polycarbonate, polyethylene terephthalate, polyarylate, polyethylene naphthalate, polysulfone, polyethersulfone, cyclo-olefin copolymer, or the like, but embodiments of the present disclosure are not limited thereto. For example, the styrene material can be an ABS material. The ABS material can be acrylonitrile, butadiene, and styrene. For example, the vibration plate 110 can be manufactured by using an injection, an extrusion, or a computer numerical control (CNC) process. For example, when the vibration plate 110 is processed, the pattern part 115 can be integrated and configured into the third region A3 without an additional process.

For example, in a graph showing a sound pressure level with respect to a frequency, when a large peak occurs in a specific frequency, large dip can occur subsequently. This can be because resonance and anti-resonance occur in the vibration plate 110 in the specific frequency. For example, resonance can cause a unique vibration, based on an impulse applied from the outside, and anti-resonance can cause the minimization of a vibration in the specific frequency. For example, when a large peak occurs in the specific frequency, a sound pressure level can increase, but the flatness of a sound pressure level curve can be reduced due to large dip which occurs subsequently, and an average sound pressure level can decrease.

Because the vibration member 100 including the pattern part 115 according to another embodiment of the present disclosure is configured, a difference between resonance and anti-resonance occurring in the vibration plate 110 can be minimized in a specific frequency, the flatness of a sound pressure level can increase. Therefore, the vibration apparatus according to an embodiment of the present disclosure can be enhanced in sound quality characteristic and/or sound characteristic. According to another embodiment of the present disclosure, the plurality of protrusion patterns 111S including a plurality of 3D patterns can be configured at a portion where a division vibration is generated in the vibration apparatus, and thus, a sound quality characteristic and/or a sound characteristic of a sound output apparatus can be more enhanced.

FIG. 7 is a cross-sectional view taken along line II-II′ illustrated in FIG. 5 according to another embodiment of the present disclosure. Except for that a protection member and an adhesive member are additionally configured, another embodiment of the present disclosure shown in FIG. 7 can be substantially the same as another embodiment of the present disclosure described above with reference to FIG. 6. Hereinafter, therefore, different elements will be described.

Referring to FIGS. 5 and 7, a vibration member 100 according to another embodiment of the present disclosure can include a vibration plate 110, a protection member 180, and an adhesive member 170. The vibration plate 110 according to another embodiment of the present disclosure shown in FIG. 7 can be configured to be substantially equal to an embodiment of the present disclosure described above with reference to FIG. 6.

According to another embodiment of the present disclosure, the protection member 180 can include a first protection member 181 and a second protection member 182.

The first protection member 181 can be configured at a first surface 110a of the vibration plate 110. The first protection member 181 can be adhered to the first surface 110a of the vibration plate 110 by using a first adhesive member 171. For example, the first protection member 181 can be configured in the first region A1 of the vibration plate 110. For example, the first protection member 181 can overlap the first region A1 of the vibration plate 110. For example, the first protection member 181 can be connected to the first region A1 of the vibration plate 110 by the first adhesive member 171. For example, the first protection member 181 can not be configured in the second region A2 and the third region A3 of the vibration plate 110. For example, the first protection member 181 can not overlap the second region A2 and the third region A3 of the vibration plate 110. For example, the first protection member 181 can protect the first surface 110a of the vibration plate 110. For example, the first protection member 181 can protect the first region A1 of the vibration plate 110. The vibration apparatus 500 can be coupled or connected to the first protection member 181 by using the connection member 400.

The second protection member 182 can be configured at a second surface 110b, differing from the first surface 110a, of the vibration plate 110. The second protection member 182 can be adhered to the second surface 110b of the vibration plate 110 by a second adhesive member 172. The second protection member 182 can be configured to cover the second surface 110b of the vibration plate 110. The second protection member 182 can protect the second surface 110b of the vibration plate 110.

The first protection member 181 and the second protection member 182 can include the same material or different materials. For example, each of the first protection member 181 and the second protection member 182 can be a polyimide film or a polyethylene terephthalate film, but embodiments of the present disclosure are not limited thereto.

The adhesive member 170 can include a first adhesive member 171 and a second adhesive member 172.

According to another embodiment of the present disclosure, the first adhesive member 171 can be configured between the first surface 110a of the vibration plate 110 and the first protection member 181. The first adhesive member 171 can connect or attach the first surface 110a of the vibration plate 110 to the first protection member 181. For example, the first adhesive member 171 can be configured in the first region A1 of the vibration plate 110. For example, the first adhesive member 171 can overlap the first region A1 of the vibration plate 110. For example, the first adhesive member 171 can not be configured in the second region A2 and the third region A3 of the vibration plate 110. For example, the first adhesive member 171 can not overlap the second region A2 and the third region A3 of the vibration plate 110.

The second adhesive member 172 can be configured between the second surface 110b of the vibration plate 110 and the second protection member 182. The second adhesive member 172 can connect or attach the second surface 110b of the vibration plate 110 to the second protection member 182. For example, the adhesive member 170 can include a foam pad, a double-sided tape, a double-sided foam pad, a double-sided foam tape, an adhesive, a double-sided adhesive, a double-sided adhesive tape, a double-sided adhesive foam pad, or an adhesive sheet, but embodiments of the present disclosure are not limited thereto. For example, when the adhesive member 170 includes an adhesive sheet (or an adhesive layer), the adhesive member 170 can include only an adhesive layer or a tacky layer without a base member such as a plastic material. For example, the adhesive layer of the adhesive member 170 can include an adhesive material such as PSA, OCA, OCR, epoxy resin, acrylic resin, silicone resin, or urethane resin, but embodiments of the present disclosure are not limited thereto.

The sound output apparatus according to another embodiment of the present disclosure shown in FIG. 7 can have the same effect as that of the sound output apparatus described above with reference to FIG. 6. Also, according to another embodiment of the present disclosure, because the vibration member 100 includes the protection member 180 and the adhesive member 170, the sound output apparatus can protect the vibration plate 110 and can be improved in flatness of a sound pressure level. For example, the adhesive member 170 can be high in damping characteristic. For example, damping can denote an operation of preventing the vibration plate 110 from moving excessively with respect to a signal when the signal is applied to the vibration plate 110. For example, a damping characteristic being high can denote that a characteristic of preventing the vibration plate 110 from moving excessively with respect to a signal is high. Therefore, because the sound output apparatus is configured, the sound output apparatus can protect the vibration plate 110 and can improve the peak and dip of a sound pressure level curve of the sound output apparatus, thereby enhancing the sound pressure level flatness of the sound output apparatus.

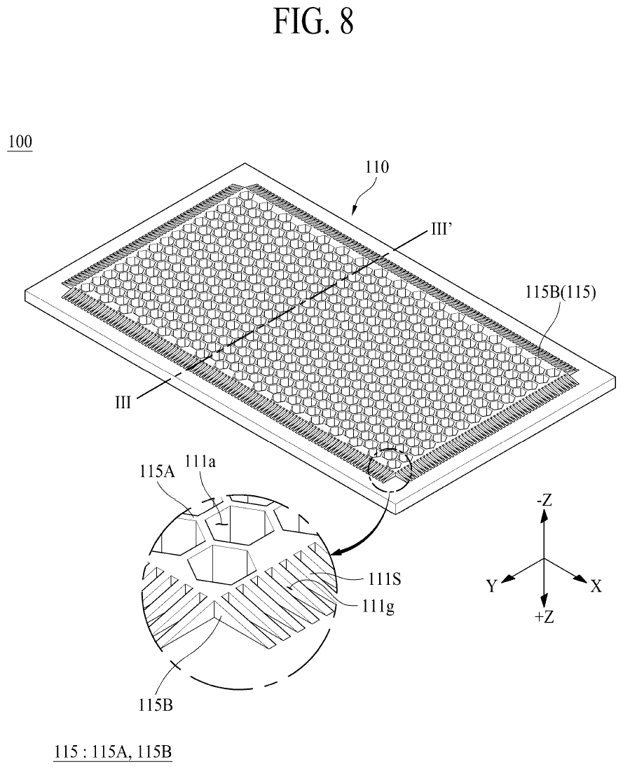

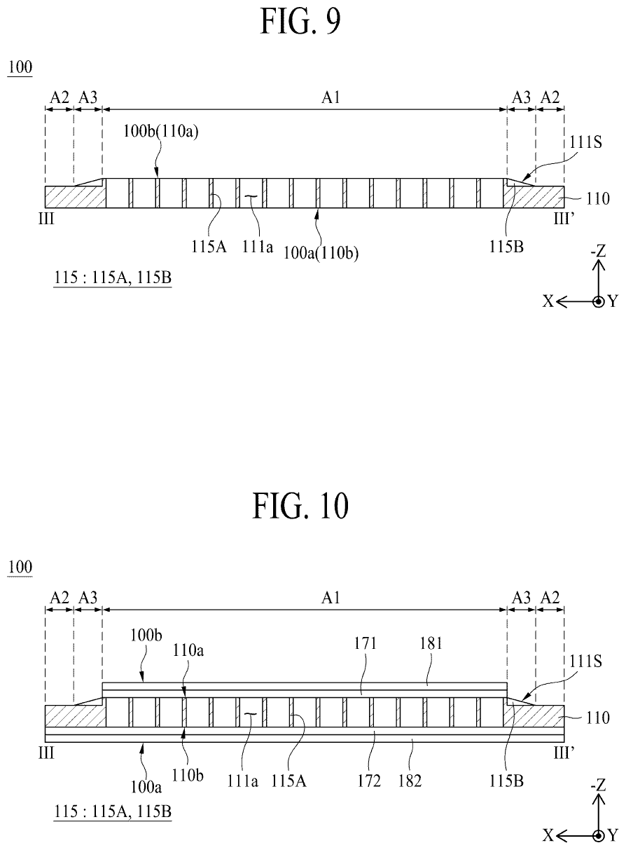

FIG. 8 is a perspective view illustrating a vibration member according to another embodiment of the present disclosure. FIG. 9 is a cross-sectional view taken along line III-III′ illustrated in FIG. 8 according to an embodiment of the present disclosure. Except for that a first pattern part is additionally configured in a first region of a vibration plate, another embodiment of the present disclosure shown in FIGS. 8 and 9 can be substantially the same as another embodiment of the present disclosure described above with reference to FIGS. 5 and 6. Hereinafter, therefore, only different elements will be described.

Referring to FIGS. 8 and 9, a vibration member 100 according to another embodiment of the present disclosure can include a vibration plate 110. The vibration plate 110 can include a first region A1, a second region A2, and a third region A3. The vibration plate 110 can include a pattern part 115. The pattern part 115 can include a first pattern part 115A and a second pattern part 115B. For example, a plurality of holes 111a can be configured in the first pattern part 115A, and a plurality of grooves 111g can be configured in the second pattern part 115B. The second pattern part 115B can be substantially the same configuration as the pattern part 115 according to another embodiment of the present disclosure described above with reference to FIGS. 5 and 6, and thus, the first pattern part 115A will be described.

According to another embodiment of the present disclosure, the first pattern part 115A can be configured in the first region A1 of the vibration plate 110. The first pattern part 115A can be configured in a center region or a middle region of the vibration plate 110. The first pattern part 115A can overlap the vibration apparatus 500. For example, the first pattern part 115A can not be configured in the second region A2 and the third region A3 of the vibration plate 110. However, embodiments of the present disclosure are not limited thereto. For example, the first pattern part 115A can be additionally configured in the third region A3 of the vibration plate 110.

The first pattern part 115A can have a honeycomb structure, based on the plurality of holes 111a. For example, each of the plurality of holes 111a can have a hexagonal shape. For example, each of the plurality of holes 111a can be an empty space which is hollow. Although each of the plurality of holes 111a is a through hole as shown in FIG. 9, it can be a blind hole disposed at any surface of the vibration plate 110. The vibration apparatus 500 can be coupled to the first surface 110a of the vibration plate 110.

According to another embodiment of the present disclosure, the vibration member 100 can include the vibration plate 110 where the pattern part 115 is configured, and thus, can enhance flexibility in a first direction (or an X-axis direction) and a second direction (or a Y-axis direction) and can enhance elasticity in a third direction (or a Z-axis direction). Accordingly, the sound output apparatus according to an embodiment of the present disclosure can increase in vibration width (or displacement width) of the vibration member 100 and can be enhanced in sound quality characteristic and/or sound pressure level characteristic of a sound output apparatus. Also, the vibration plate 110 can include the first pattern part 115A where the plurality of holes 111a are configured, and thus, can reduce a weight of the vibration member 110.

As another example, each of the plurality of holes 111a can be filled by resin or accommodates the resin. For example, the resin can be filled in each of the plurality of holes 111a. For example, the resin can include epoxy resin, acrylic resin, silicone resin, polycarbonate resin, or urethane resin, but embodiments of the present disclosure are not limited thereto. For example, in a case where the resin is filled in each of the plurality of holes 111a, the vibration apparatus 500 and the vibration member 100 can be connected to each other without a separate connection member 400 by using a process of curing the resin. For example, in a case where the resin is filled in each of the plurality of holes 111a, a configuration of the connection member 400 which is disposed between the vibration apparatus 500 and the vibration member 100 to connect the vibration apparatus 500 to the vibration member 100 can be omitted. However, embodiments of the present disclosure are not limited thereto.

According to another embodiment of the present disclosure, because the vibration member 110 includes the first pattern part 115A and the second pattern part 115B, a sound quality characteristic and/or a sound pressure level characteristic of the sound output apparatus can be more enhanced. According to another embodiment of the present disclosure, the resin can be filled in the plurality of holes 111a, and the first protection member 181 can be attached to the second protection member 182, and thus, a division vibration can be attenuated, thereby more improving a sound quality characteristic and/or a sound pressure level characteristic of the sound output apparatus.

FIG. 10 is a cross-sectional view taken along line III-III′ illustrated in FIG. 8 according to another embodiment of the present disclosure. Except for that a protection member and an adhesive member are additionally configured, another embodiment of the present disclosure shown in FIG. 10 can be substantially the same as an embodiment of the present disclosure described above with reference to FIG. 9. Hereinafter, therefore, only different elements will be described.

Referring to FIG. 10, a vibration member 100 according to another embodiment of the present disclosure can include a vibration plate 110, a protection member 180, and an adhesive member 170. The vibration plate 110 according to another embodiment of the present disclosure shown in FIG. 10 can be substantially the same as an embodiment of the present disclosure described above with reference to FIG. 9. The protection member 180 and the adhesive member 170 according to another embodiment of the present disclosure shown in FIG. 10 can be substantially the same as the protection member 180 and the adhesive member 170 according to an embodiment of the present disclosure described above with reference to FIG. 7. Hereinafter, therefore, the same elements will be briefly described, and different elements will be described.

According to another embodiment of the present disclosure, the first protection member 181 can be configured in a first region A1 of the vibration plate 110. The first protection member 181 can overlap a first pattern part 115A configured in the first region A1 of the vibration plate 110. The first protection member 181 can cover the first pattern part 115A configured in the first region A1 of the vibration plate 110. For example, the first protection member 181 can be connected to the first region A1 of the vibration plate 110 by using a first adhesive member 171. For example, the first protection member 181 can be attached to the first pattern part 115A configured in the first region A1 of the vibration plate 110 by using the first adhesive member 171. For example, the first protection member 181 can not be configured in a second region A2 and a third region A3 of the vibration plate 110. For example, the first protection member 181 can not overlap a second pattern part 115B configured in the third region A3 of the vibration plate 110. For example, the first protection member 181 can not contact the second pattern part 115B configured in the third region A3 of the vibration plate 110. However, embodiments of the present disclosure are not limited thereto. The vibration apparatus 500 can be coupled or connected to the first protection member 181 to overlap the first pattern part 115A by using a connection member 400.

According to another embodiment of the present disclosure, the first adhesive member 171 can be configured between a first surface 110a of the vibration plate 110 and the first protection member 181. For example, the first adhesive member 171 can be configured in the first region A1 of the vibration plate 110. For example, the first adhesive member 171 can overlap the first pattern part 115A configured in the first region A1 of the vibration plate 110. For example, the first adhesive member 171 can cover the first pattern part 115A configured in the first region A1 of the vibration plate 110. For example, the first adhesive member 171 can directly contact the first pattern part 115A configured in the first region A1 of the vibration plate 110. For example, the first adhesive member 171 can not be configured in the second region A2 and the third region A3 of the vibration plate 110. For example, the first adhesive member 171 can not overlap the second pattern part 115B configured in the third region A3 of the vibration plate 110. For example, the first adhesive member 171 can not contact the second pattern part 115B configured in the third region A3 of the vibration plate 110. However, embodiments of the present disclosure are not limited thereto.

As another example, the first protection member 181 and the first adhesive member 171 can be configured in an entire upper surface (or a first surface) of each of the first to third regions A1 to A3 of the vibration plate 110. In this case, a thickness of the first adhesive member 171 overlapping each of the first to third regions A1 to A3 can be differently adjusted, or an adhesive can be additionally configured in the second region A2 and the third region A3, and thus, the first protection member 181 and the first adhesive member 171 can be adhered to the vibration plate 110 without a step height. Similarly, the first protection member 181 and the first adhesive member 171 can be configured in an entire upper surface (or a first surface) of each of the first to third regions A1 to A3 of the vibration plate 110 in the embodiment as shown in FIG. 7.

According to another embodiment of the present disclosure, because the vibration member 110 includes the first pattern part 115A and the second pattern part 115B, a sound quality characteristic and/or a sound pressure level characteristic of the sound output apparatus can be more enhanced. Also, because the vibration member 100 includes the protection member 180 and the adhesive member 170, the sound output apparatus can protect the vibration plate 110, and the flatness of a sound pressure level can be improved. According to another embodiment of the present disclosure, resin can be filled in the plurality of holes 111a, and the first protection member 181 can be attached to the second protection member 182, and thus, a division vibration can be attenuated, thereby more improving a sound quality characteristic.

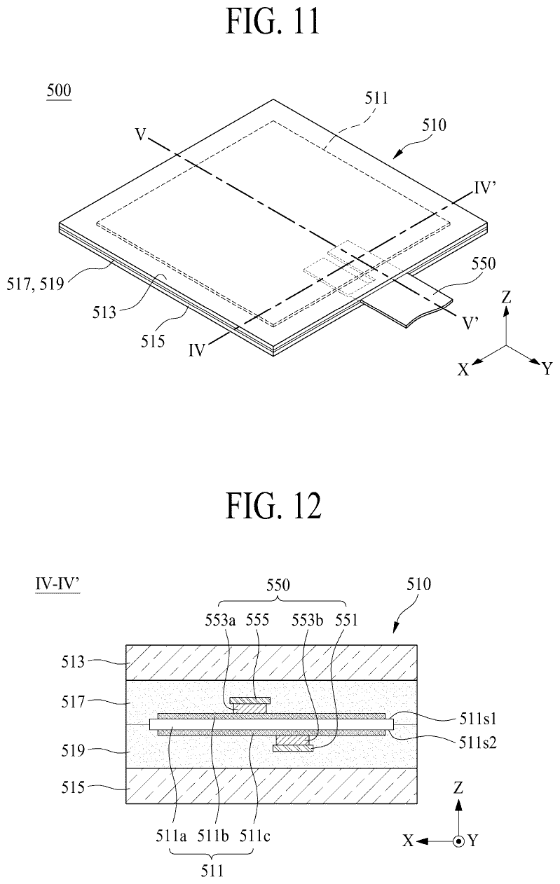

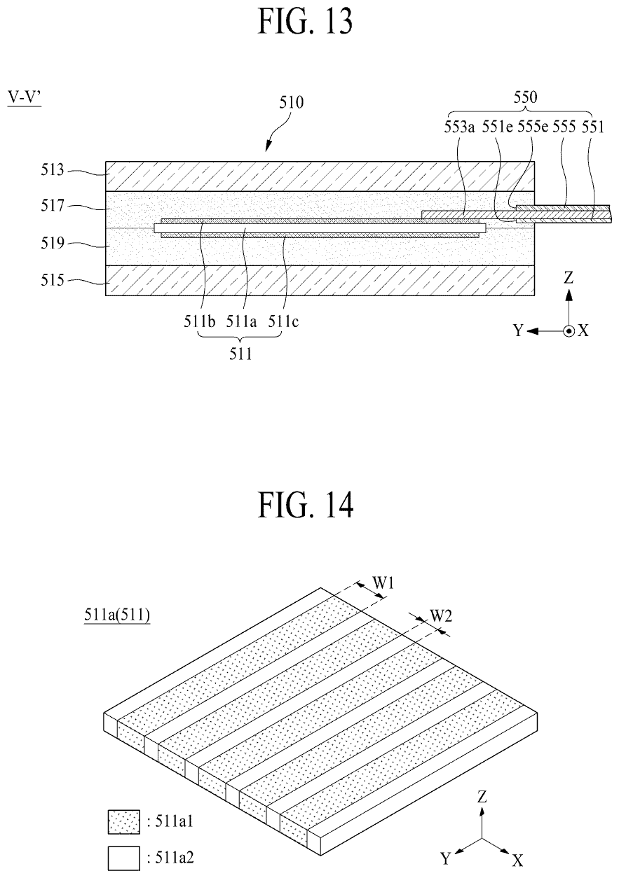

FIG. 11 is a perspective view illustrating a vibration apparatus according to an embodiment of the present disclosure. FIG. 12 is a cross-sectional view taken along line IV-IV′ illustrated in FIG. 11 according to an embodiment of the present disclosure. FIG. 13 is a cross-sectional view taken along line V-V′ illustrated in FIG. 11 according to an embodiment of the present disclosure. FIGS. 11 to 13 illustrate examples of the vibration apparatus or the plurality of vibration generating apparatuses described above with reference to FIGS. 1 and 2.

Referring to FIGS. 11 to 13, the vibration apparatus 500 can include a vibration generating part 510.

The vibration generating part 510 can include a piezoelectric material having a piezoelectric characteristic. The vibration generating part 510 can be configured as a ceramic-based piezoelectric material for implementing a relatively strong vibration, or can be configured as a piezoelectric ceramic having a perovskite-based crystal structure. For example, the vibration generating part 510 can be a vibration generating device, a vibration film, a vibration generating film, a vibrator, a vibration generator, an active vibrator, an active vibration generator, an actuator, an exciter, a film actuator, a film exciter, an ultrasonic actuator, an active vibration member, or the like, but embodiments of the present disclosure are not limited thereto.

The vibration generating part 510 according to an embodiment of the present disclosure can include a vibration part 511.

The vibration part 511 can be configured to vibrate in response to a driving signal due to the piezoelectric effect. The vibration part 511 can include at least one or more of a piezoelectric inorganic material and a piezoelectric organic material. For example, the vibration part 511 can be a vibration element, a piezoelectric device, a piezoelectric element, a piezoelectric device part, a piezoelectric device layer, a piezoelectric structure, a piezoelectric vibration part, or a piezoelectric vibration layer, but embodiments of the present disclosure are not limited thereto.

The vibration part 511 according to an embodiment of the present disclosure can include a vibration layer 511a, a first electrode layer 511b, and a second electrode layer 511c.

The vibration layer 511a can include a piezoelectric material or an electroactive material which has a piezoelectric effect. For example, the piezoelectric material can have a characteristic in which, when a pressure or twisting phenomenon is applied to a crystalline structure by an external force, a potential difference occurs due to dielectric polarization caused by a relative position change of a positive (+) ion and a negative (−) ion, and thus a vibration is generated by an electric field based on a reverse voltage applied thereto. For example, the vibration layer 511a can be a piezoelectric layer, a piezoelectric material layer, an electroactive layer, a piezoelectric composite layer, a piezoelectric composite, or a piezoelectric ceramic composite, or the like, but embodiments of the present disclosure are not limited thereto.

The vibration layer 511a can be configured as a ceramic-based material for implementing a relatively strong vibration (e.g., high amplitude vibration), or can be configured as a piezoelectric ceramic having a perovskite-based crystalline structure. The perovskite crystalline structure can have a piezoelectric effect and/or an inverse piezoelectric effect and can be a plate-shaped structure having orientation.

The piezoelectric ceramic can be configured as a single crystalline ceramic having a crystalline structure, or can be configured as a ceramic material having a polycrystalline structure or polycrystalline ceramic. A piezoelectric material including the single crystalline ceramic can include α-AlPO₄, α-SiO₂, LiNbO₃, Tb₂(MoO₄)₃, Li₂B₄O₇, or ZnO, but embodiments of the present disclosure are not limited thereto. A piezoelectric material including the polycrystalline ceramic can include a lead zirconate titanate (PZT)-based material, including lead (Pb), zirconium (Zr), and/or titanium (Ti), or can include a lead zirconate nickel niobate (PZNN)-based material, including lead (Pb), zirconium (Zr), nickel (Ni), and/or niobium (Nb), but embodiments of the present disclosure are not limited thereto. For example, the vibration layer 511a can include at least one or more of calcium titanate (CaTiO₃), barium titanate (BaTiO₃), and strontium titanate (SrTiO₃), without lead (Pb), but embodiments of the present disclosure are not limited thereto.

The first electrode layer 511b can be disposed at a first surface (or an upper surface or a front surface) 511s1 of the vibration layer 511a. The first electrode layer 511b can have the same size as that of the vibration layer 511a, or can have a size which is smaller than that of the vibration layer 511a.

The second electrode layer 511c can be disposed at a second surface (or a lower surface or a rear surface) 511s2 which is opposite to or different from the first surface 511s1 of the vibration layer 511a. The second electrode layer 511c can have the same size as that of the vibration layer 511a, or can have a size which is smaller than that of the vibration layer 511a. For example, the second electrode layer 511c can have a same or similar shape as the vibration layer 511a, but embodiments of the present disclosure are not limited thereto.

According to an embodiment of the present disclosure, in order to prevent electrical short circuit between the first electrode layer 511b and the second electrode layer 511c, each of the first electrode layer 511b and the second electrode layer 511c can be formed at another portion, except a periphery portion, of the vibration layer 511a. For example, the first electrode layer 511b can be formed at an entire first surface 511s1, other than a periphery portion, of the vibration layer 511a. For example, the second electrode layer 511c can be formed at an entire second surface 511s2, other than a periphery portion, of the vibration layer 511a. For example, a distance between a lateral surface (or a periphery, perimeter or sidewall) of each of the first electrode layer 511b and the second electrode layer 511c and a lateral surface (or a periphery, perimeter or sidewall) of the vibration layer 511a can be at least 0.5 mm or more. For example, the distance between the lateral surface of each of the first electrode layer 511b and the second electrode layer 511c and the lateral surface of the vibration layer 511a can be at least 1 mm or more, but embodiments of the present disclosure are not limited thereto.

According to an embodiment of the present disclosure, one or more of the first electrode layer 511b and the second electrode layer 511c can be formed of a transparent conductive material, a semitransparent conductive material, or an opaque conductive material. For example, the transparent conductive material or the semitransparent conductive material can include indium tin oxide (ITO) or indium zinc oxide (IZO), but embodiments of the present disclosure are not limited thereto. The opaque conductive material can include gold (Au), silver (Ag), platinum (Pt), palladium (Pd), molybdenum (Mo), magnesium (Mg), carbon, or silver (Ag) including glass frit, or the like, or can be made of an alloy thereof, but embodiments of the present disclosure are not limited thereto. For example, to enhance an electrical characteristic and/or a vibration characteristic of the vibration layer 511a, each of the first electrode layer 511b and the second electrode layer 511c can include silver (Ag) having a low resistivity. For example, carbon can include one or more of carbon black, ketjen black, carbon nanotube, and a carbon material including graphite, but embodiments of the present disclosure are not limited thereto.

The vibration layer 511a can be polarized (or poling) by a certain voltage applied to the first electrode layer 511b and the second electrode layer 511c in a certain temperature atmosphere, or a temperature atmosphere that can be changed from a high temperature to a room temperature, but embodiments of the present disclosure are not limited thereto. For example, a polarization direction (or a poling direction) formed in the vibration layer 511a can be formed or aligned (or arranged) from the first electrode layer 511b to the second electrode layer 511c, but is not limited thereto, and a polarization direction (or a poling direction) formed in the vibration layer 511a can be formed or aligned (or arranged) from the second electrode layer 511c to the first electrode layer 511b.

The vibration layer 511a can alternately and repeatedly contract and/or expand due to an inverse piezoelectric effect according to a driving signal applied to the first electrode layer 511b and the second electrode layer 511c from the outside to vibrate. For example, the vibration layer 511a can vibrate in a vertical direction (or thickness direction) and in a planar direction by the signal applied to the first electrode layer 511b and the second electrode layer 511c. The vibration layer 511a can be displaced (or vibrated or driven) by contraction and/or expansion of the planar direction, thereby improving a sound characteristic and/or a sound pressure level characteristic of the vibration generating part 510.

The vibration generating part 510 according to an embodiment of the present disclosure can further include a first cover member 513 and a second cover member 515.

The first cover member 513 can be disposed at a first surface of the vibration part 511. For example, the first cover member 513 can be configured to cover the first electrode layer 511b of the vibration part 511. For example, the first cover member 513 can be configured to have a larger size than the vibration part 511. The first cover member 513 can be configured to protect the first surface of the vibration part 511 and the first electrode layer 511b.

The second cover member 515 can be disposed at a second surface of the vibration part 511. For example, the second cover member 515 can be configured to cover the second electrode layer 511c of the vibration part 511. For example, the second cover member 515 can be configured to have a larger size than the vibration part 511. The second cover member 515 can be configured to protect the second surface of the vibration part 511 and the second electrode layer 511c.

Each of the first cover member 513 and the second cover member 515 according to an embodiment of the present disclosure, can include the same material or a different material. For example, one or each of the first cover member 513 and the second cover member 515 can be or include a polyimide film or a polyethylene terephthalate film, but embodiments of the present disclosure are not limited thereto.

The first cover member 513 can be connected or coupled to the first surface of the vibration part 511 or the first electrode layer 511b by a first adhesive layer 517. For example, the first cover member 513 can be connected or coupled to the first surface of the vibration part 511 or the first electrode layer 511b by a film laminating process by the first adhesive layer 517.

The second cover member 515 can be connected or coupled to the second surface of the vibration part 511 or the second electrode layer 511c by a second adhesive layer 519. For example, the second cover member 515 can be connected or coupled to the second surface of the vibration part 511 or the second electrode layer 511c by a film laminating process by the second adhesive layer 519.

Each of the first adhesive layer 517 and second adhesive layer 519 according to an embodiment of the present disclosure can include an electrically insulating material which has adhesiveness and is capable of compression and decompression. For example, each of the first adhesive layer 517 and the second adhesive layer 519 can include an epoxy resin, an acrylic resin, a silicone resin, or a urethane resin, but embodiments of the present disclosure are not limited thereto.

The first adhesive layer 517 and second adhesive layer 519 can be configured between the first cover member 513 and the second cover member 515 to surround the vibration part 511. For example, one or more of the first adhesive layer 517 and second adhesive layer 519 can be configured to surround the vibration part 511.

The vibration apparatus 500 or a vibration generating part 510 according to an embodiment of the present disclosure can each further include a signal supply member 550.

The signal supply member 550 can be configured to supply the driving signal supplied from a driving circuit part to the vibration part 511. The signal supply member 550 can be configured to be electrically connected to the vibration part 511. The signal supply member 550 can be configured to be electrically connected to the first electrode layer 511b and the second electrode layer 511c.

A portion of the signal supply member 550 can be accommodated (or inserted) between the first cover member 513 and the second cover member 515. An end portion (or a distal end portion or one side or one portion) of the signal supply member 550 can be disposed or inserted (or accommodated) between one edge portion (or one periphery portion) of the first cover member 513 and one edge portion (or one periphery portion) of the second cover member 515. The one edge portion of the first cover member 513 and the one edge portion of the second cover member 515 can accommodate or vertically (or up and down) cover the end portion (or the distal end portion or the one side or one portion) of the signal supply member 550. Accordingly, the signal supply member 550 can be configured (or integrated) as one body with the vibration generating part 510. For example, the signal supply member 550 can be configured as a signal cable, a flexible cable, a flexible printed circuit cable, a flexible flat cable, a single-sided flexible printed circuit, a single-sided flexible printed circuit board, a flexible multilayer printed circuit, or a flexible multilayer printed circuit board, but embodiments of the present disclosure are not limited thereto.

The signal supply member 550 according to an embodiment of the present disclosure can include a base member 551 and a plurality of signal lines. For example, the signal supply member 550 can include a base member 551, a first signal line 553a, and a second signal line 553b.

The base member 551 can include a transparent or opaque plastic material, but embodiments of the present disclosure are not limited thereto. The base member 551 can have a certain width along a first direction X and can be extended long along a second direction Y intersecting with the first direction X.

The first and second signal lines 553a and 553b can be disposed at the first surface of the base member 551 in parallel with the second direction Y, and can be spaced apart from each other or electrically separated from each other along the first direction X. The first and second signal lines 553a and 553b can be disposed in parallel to each other at the first surface of the base member 551. For example, the first and second signal lines 553a and 553b can be implemented in a line shape by patterning of a metal layer (or a conductive layer) formed or deposited at the first surface of the base member 551.

End portions (or distal end portions or one sides or one portions) of the first and second signal lines 553a and 553b can be separated from each other, and thus, can be individually curved or bent.

The end portion (or the distal end portion or the one side or one portion) of the first signal line 553a can be electrically connected to the first electrode layer 511b of the vibration part 511. For example, the end portion of the first signal line 553a can be electrically connected to at least a portion of the first electrode layer 511b of the vibration part 511 at or near one edge portion of the first cover member 513. For example, the end portion (or the distal end portion or the one side or one portion) of the first signal line 553a can be electrically and directly connected to at least a portion of the first electrode layer 511b of the vibration part 511. For example, the end portion (or the distal end portion or the one side or one portion) of the first signal line 553a can be electrically connected to or directly contact the first electrode layer 511b of the vibration part 511. For example, the end portion of the first signal line 553a can be electrically connected to the first electrode layer 511b by a conductive double-sided tape. Accordingly, the first signal line 553a can be configured to transfer a first driving signal, supplied from a vibration driver, to the first electrode layer 511b of the vibration part 511.

The end portion (or the distal end portion or the one side or one portion) of the second signal line 553b can be electrically connected to the second electrode layer 511c of the vibration part 511. For example, the end portion of the second signal line 553b can be electrically connected to at least a portion of the second electrode layer 511c of the vibration part 511 at one edge portion of the second cover member 515. For example, the end portion of the second signal line 553b can be electrically and directly connected to at least a portion of the second electrode layer 511c of the vibration part 511. For example, the end portion of the second signal line 553b can be electrically connected to or directly contact the second electrode layer 511c of the vibration part 511. For example, the end portion of the second signal line 553b can be electrically connected to the second electrode layer 511c by a conductive double-sided tape. Accordingly, the second signal line 553b can be configured to transfer a second driving signal, suppled from the vibration driver, to the second electrode layer 511c of the vibration part 511.

The signal supply member 550 according to an embodiment of the present disclosure can further include an insulation layer 555.

The insulation layer 555 can be disposed at the first surface of the base member 551 to cover each of the first signal line 553a and the second signal line 553b other than the end portion (or one side or one portion) of the signal supply member 550.

An end portion (or one side or one portion) of the signal supply member 550 including an end portion (or one side or one portion) of the base member 551 and an end portion (or one side or one portion) of the insulation layer 555 can be inserted (or accommodated) between the first cover member 513 and the second cover member 515 and can be fixed between the first cover member 513 and the second cover member 515 by the first adhesive layer 517 and the second adhesive layer 519. Accordingly, the end portion (or one side or one portion) of the first signal line 553a can be maintained with being electrically connected to the first electrode layer 511b of the vibration part 511, and the end portion (or one side or one portion) of the second signal line 553b can be maintained with being electrically connected to the second electrode layer 511c of the vibration part 511. Further, the end portion (or one side or one portion) of the signal supply member 550 can be inserted (or accommodated) and fixed between the vibration part 511 and the first cover member 513, and thus, a contact defect between the vibration generating part 510 and the signal supply member 550 caused by the movement of the signal supply member 550 can be prevented. Alternatively, the end portion (or one side or one portion) of the signal supply member 550 can be inserted (or accommodated) and fixed between the vibration part 511 and the second cover member 515.

In the signal supply member 550 according to an embodiment of the present disclosure, each of the end portion (or one side or one portion) of the base member 551 and the end portion (or one side or one portion) of the insulation layer 555 can be disposed from the end portions of the signal lines by a certain distance. For example, each of the end portion of the first signal line 553a and the end portion of the second signal line 553b can be exposed at the outside (e.g., next to the end of the vibration part 511) without being supported or covered by each of the end portion (or one side) of the base member 551 and the end portion (or one side or one portion) of the insulation layer 555, respectively. For example, the end portion of each of the first and second signal lines 553a and 553b can protrude (or extend) to have a certain length from an end 551e of the base member 551 or an end 555e of the insulation layer 555. Accordingly, each of the end portion (or the distal end portion or the one side or one portion) of each of the first and second signal lines 553a and 553b can be individually or independently curved (or bent), independently of the base member 551 and the insulation layer 555.

The end portion (or one side or one portion) of the first signal line 553a, which is not supported by the end portion (or one side or one portion) of the base member 551 and the end portion of the insulation layer 555, can be directly connected to or directly contact the first electrode layer 511b of the vibration part 511. The end portion (or one side or one portion) of the second signal line 553b, which is not supported by the end portion (or one side or one portion) of the base member 551 and the end portion of the insulation layer 555, can be directly connected to or directly contact the second electrode layer 511c of the vibration part 511.

According to an embodiment of the present disclosure, a portion of the signal supply member 550 or a portion of the base member 551 can be disposed or inserted (or accommodated) between the first cover member 513 and the second cover member 515, and thus, the signal supply member 550 can be configured (or integrated) as one body with the vibration generating part 510. Accordingly, the vibration generating part 510 and the signal supply member 550 can be configured as one part (or an element or one component), and thus, an effect of uni-materialization can be obtained. For instance, a single component can be obtained which can then be easily and efficiently installed in the sound output apparatus according to embodiments of the present disclosure.

According to an embodiment of the present disclosure, the first signal line 553a and the second signal line 553b of the signal supply member 550 can be configured (or integrated) as one body with the vibration generating part 510, and thus, a soldering process for an electrical connection between the vibration generating part 510 and the signal supply member 550 can not be needed. Accordingly, a manufacturing process and a structure of the vibration apparatus 500 can be simplified, and thus, the expense, time and hazards associated with a soldering process are avoided.

FIG. 14 is a perspective view illustrating a vibration layer according to another embodiment of the present disclosure. FIG. 14 illustrates another example of the vibration layer (e.g., 511a) described above with reference to FIGS. 11 to 13.

Referring to FIGS. 11 and 14, the vibration layer 511a according to another embodiment of the present disclosure can include a plurality of first portions 511a1 and a plurality of second portions 511a2. For example, the plurality of first portions 511a1 and the plurality of second portions 511a2 can be alternately and repeatedly disposed along a first direction X (e.g., X-direction) or a second direction Y (e.g., Y-direction).

Each of the plurality of first portions 511al can include an inorganic material portion having a piezoelectric effect (or a piezoelectric characteristic). For example, each of the plurality of first portions 511al can include at least one or more of a piezoelectric inorganic material and a piezoelectric organic material. For example, each of the plurality of first portions 511al can be an inorganic portion, an inorganic material portion, a piezoelectric portion, a piezoelectric material portion, or an electroactive portion, but embodiments of the present disclosure are not limited thereto.

According to an embodiment of the present disclosure, each of the plurality of first portions 511al can have a first width W1 parallel to the first direction X (or the second direction Y) and can be extended along the second direction Y (or the first direction X). Each of the plurality of first portions 511al can include a material which is substantially the same as a vibration layer 511a described above with reference to FIGS. 4 to 6, and thus, repeated descriptions thereof are omitted or can be briefly discussed.

Each of the plurality of second portions 511a2 can be disposed between the plurality of first portions 511a1. For example, each of the plurality of first portions 511al can be disposed between two adjacent second portions 511a2 of the plurality of second portions 511a2. Each of the plurality of second portions 511a2 can have a second width W2 parallel to the first direction X (or the second direction Y) and can be extended along the second direction Y (or the first direction X). The first width W1 can be the same as or different from the second width W2. For example, the first width W1 can be greater than the second width W2. For example, the first portion 511al and the second portion 511a2 can include a line shape or a stripe shape which has the same size or different sizes.

Each of the plurality of second portions 511a2 can be configured to fill a gap between two adjacent first portions of the plurality of first portions 511a1, and thus, can be connected to or attached on lateral surfaces of the first portion 511al adjacent thereto. According to an embodiment of the present disclosure, each of the plurality of first portions 511al and the plurality of second portions 511a2 can be disposed (or arranged) at the same plane (or the same layer) in parallel with each other. Therefore, the vibration layer 511a can be expanded to a desired size or length by a lateral coupling (or connection) of first portions 511al and second portions 511a2.

According to an embodiment of the present disclosure, each of the plurality of second portions 511a2 can absorb an impact applied to the first portions 511a1, and thus, can enhance the total durability of the first portions 511al and provide flexibility to the vibration layer 511a. Each of the plurality of second portions 511a2 can include an organic material having a ductile (e.g., soft and/or elastic) characteristic. For example, each of the plurality of second portions 511a2 can include one or more of an epoxy-based polymer, an acrylic-based polymer, and a silicone-based polymer, but embodiments of the present disclosure are not limited thereto. For example, each of the plurality of second portions 511a2 can be an organic portion, an organic material portion, an adhesive portion, a stretch portion, a bending portion, a damping portion, or a ductile (e.g., soft and/or elastic) portion, but embodiments of the present disclosure are not limited thereto.

A first surface of each of the plurality of first portions 511al and the plurality of second portions 511a2 can be connected to the first electrode layer 511b in common. A second surface of each of the plurality of first portions 511al and the plurality of second portions 511a2 can be connected to the second electrode layer 511c in common.

The plurality of first portions 511al and the plurality of second portion 511a2 can be disposed on (or connected to) the same plane, and thus, the vibration layer 511a according to another embodiment of the present disclosure can have a single thin film-type. Accordingly, the vibration part 511 or the vibration generating part 510 including the vibration layer 511a according to another embodiment of the present disclosure can vibrate by the first portion 511al having a vibration characteristic and can be bent in a curved shape by the second portion 511a2 having flexibility.

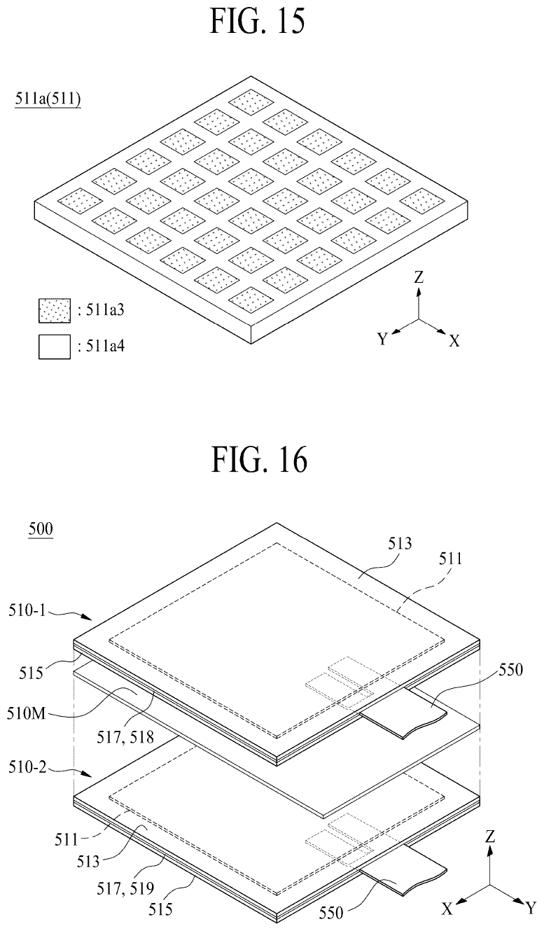

FIG. 15 is a perspective view illustrating a vibration layer according to another embodiment of the present disclosure. FIG. 15 illustrates another example of the vibration layer (e.g., 511a) described above with reference to FIGS. 11 to 13.

Referring to FIGS. 11 and 15, the vibration layer 511a according to another embodiment of the present disclosure can include a plurality of first portions 511a3 and a second portion 511a4 disposed between the plurality of first portions 511a3.

Each of the plurality of first portions 511a3 can be disposed to be spaced apart from one another along each of the first direction X and the second direction Y. For example, each of the plurality of first portions 511a3 can have a hexahedral shape having the same size (e.g., a cube shape) and can be disposed in a lattice shape, but embodiments of the present disclosure are not limited thereto. For example, each of the plurality of first portions 511a3 can have a circular shape plate, an oval shape plate, or a polygonal shape plate, which has the same size as each other, but embodiments of the present disclosure are not limited thereto.

Each of the plurality of first portions 511a3 is substantially the same as the first portion 511a1 described above with reference to FIG. 14, and thus, repeated descriptions thereof are omitted or can be briefly discussed.

The second portion 511a4 can be disposed between the plurality of first portions 511a3 along each of the first direction X and the second direction Y. The second portion 511a4 can be configured to fill a gap between two adjacent first portions 511a3 or to surround each of the plurality of first portions 511a3, and thus, the second portion 511a4 can be connected to or attached on the first portion 511a3 adjacent thereto. The second portion 511a4 is substantially the same as the second portion 511a2 described above with reference to FIG. 14, and thus, repeated descriptions thereof are omitted or can be briefly discussed.

A first surface of each of the plurality of first portions 511a3 and the second portions 511a4 can be connected to the first electrode layer 511b in common. A second surface of each of the plurality of first portions 511a3 and the second portions 511a4 can be connected to the second electrode layer 511c in common.

The plurality of first portions 511a3 and the second portion 511a4 can be disposed on (or connected to) the same plane, and thus, the vibration layer 511a according to another embodiment of the present disclosure can have a single thin film-type. Accordingly, the vibration part 511 or the vibration generating part 510 including the vibration layer 511a according to another embodiment of the present disclosure can vibrate by the first portion 511a3 having a vibration characteristic and can be bent in a curved shape by the second portion 511a4 having flexibility.

FIG. 16 is an exploded perspective view illustrating a vibration apparatus according to another embodiment of the present disclosure. FIG. 16 illustrates the vibration apparatus described above with reference to FIGS. 1 and 2.

Referring to FIGS. 2 and 16, a vibration apparatus 500 according to another embodiment of the present disclosure can include two or more vibration generating part. For example, the vibration apparatus 500 can include a first vibration generating part 510-1 and a second vibration generating part 510-2.

The first vibration generating part 510-1 and the second vibration generating part 510-2 can overlap or be stacked to be displaced (or driven or vibrated) in the same direction, so as to maximize an amplitude displacement of the vibration apparatus 500 and/or an amplitude displacement of the vibration member. For example, the first vibration generating part 510-1 and the second vibration generating part 510-2 can have substantially the same size, but embodiments of the present disclosure are not limited thereto. For example, the first vibration generating part 510-1 and the second vibration generating part 510-2 can have the same size within an error range of a manufacturing process. Accordingly, the first vibration generating part 510-1 and the second vibration generating part 510-2 can maximize the amplitude displacement of the vibration apparatus 500 and/or the amplitude displacement of the vibration member.

According to an embodiment of the present disclosure, one of the first vibration generating part 510-1 and the second vibration generating part 510-2 can be connected or coupled to the vibration member 100 by the connection member 400 illustrated in FIG. 2. For example, the first vibration generating part 510-1 can be connected or coupled to the vibration member 100 by the connection member 400.

Each of the first vibration generating part 510-1 and the second vibration generating part 510-2 can be the same or substantially the same as the vibration generating part 510 described above with reference to FIGS. 11 to 13, and thus, like reference numerals can refer to like elements, and repeated descriptions thereof can be omitted.

The vibration apparatus 500 according to another embodiment of the present disclosure shown in FIG. 16 can further include a middle member 510M.

The middle member 510M can be disposed or connected between the first vibration generating part 510-1 and the second vibration generating part 510-2. For example, the middle member 510M can be disposed or connected between a second cover member 515 of the first vibration generating part 510-1 and a first cover member 513 of the second vibration generating part 510-2. For example, the middle member 510M can be an adhesive member or a connection member, but embodiments of the present disclosure are not limited thereto.

The middle member 510M according to an embodiment of the present disclosure can include a material including an adhesive layer where an adhesive force or an attaching force is good with respect to the first vibration generating part 510-1 and the second vibration generating part 510-2. For example, the middle member 510M can include a foam pad, a double-sided tape, a double-sided foam tape, a double-sided foam pad, or an adhesive, but embodiments of the present disclosure are not limited thereto. For example, the adhesive layer of the middle member 510M can include epoxy, acryl, silicone, or urethane, but embodiments of the present disclosure are not limited thereto. For example, the adhesive layer of the middle member 510M can include a urethane-based material (or substance) having a relatively ductile characteristic. Accordingly, vibration loss caused by displacement interference between the first vibration generating part 510-1 and the second vibration generating part 510-2 can be minimized, or each of the first vibration generating part 510-1 and the second vibration generating part 510-2 can be freely displaced (or vibrated or driven).

According to another embodiment of the present disclosure, since the vibration apparatus 500 according to another embodiment of the present disclosure includes the first vibration generating part 510-1 and the second vibration generating part 510-2 which are stacked (or piled or overlap) to vibrate (or displace or drive) in the same direction, the amount of displacement or an amplitude displacement can be maximized or increase, and thus, the amount of displacement (or bending force or driving force) or an amplitude displacement of a vibration member can be maximized or increase.

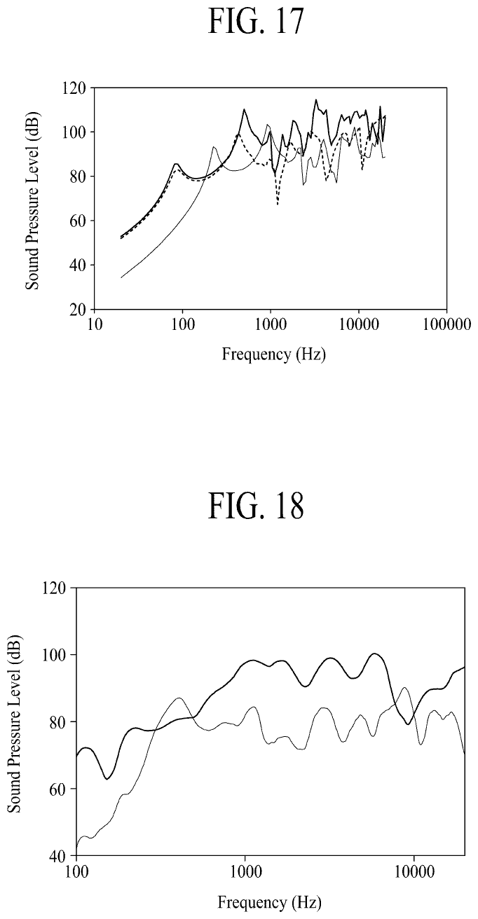

FIG. 17 is a graph showing a sound pressure level characteristic of a sound output apparatus according to an experiment example and embodiments of the present disclosure.

The inventors have prepared an experiment example 1, an embodiment 1, and an embodiment 2 as samples, so as to compare a sound pressure level of the sound output apparatus according to embodiments of the present disclosure. The experiment example 1 has prepared the sample by coupling the vibration apparatus to a vibration member which includes aluminum and where a pattern part is not formed. The embodiment 1 is the sound output apparatus according to an embodiment of the present disclosure described above with reference to FIGS. 2 and 3 and has prepared the sample by coupling the vibration apparatus to a vibration member where a pattern part is configured. The embodiment 2 is the sound output apparatus according to an embodiment of the present disclosure described above with reference to FIGS. 2 and 4 and has prepared the sample by coupling the vibration apparatus to a vibration member where a pattern part, a protection member, and a coupling member are configured. The vibration member of the embodiment 1 and the vibration member of the embodiment 2 include aluminum. A sound output characteristic of the sound output apparatus with respect to a frequency has been measured in an anechoic chamber. For example, measurement has been performed under a condition where an applied voltage is 5 Vrms and an applied frequency signal is applied as a sine sweep within a range of 20 Hz to 20 kHz, and ⅓ octave smoothing has been performed on a measurement result.

In the experiment example 1, the embodiment 1, and the embodiment 2, sizes of the vibration members have been identically prepared to have a width of 200 mm, a height of 200 mm, and a thickness of 0.1 mm. In the experiment example 1, the embodiment 1, and the embodiment 2, sizes of the vibration apparatuses have been identically prepared to have a width of 120 mm, a height of 60 mm, and a thickness of 0.16 mm. In FIG. 17, the abscissa axis represents a frequency (Hz (hertz)), and the ordinate axis represents a sound pressure level (SPL) (dB (decibel)). In FIG. 17, a thin solid line, a thick solid line, and a dotted line respectively represent the experiment example 1, the embodiment 1, and the embodiment 2. An experiment condition of FIG. 17 does not limit the details of the present disclosure.

The following Table 1 can be a table which shows the sound performance of sound output apparatuses according to the experiment example 1, the embodiment 1, and the embodiment 2. In Table 1, a standard deviation can be a standard deviation of a sound curve and can represent the flatness of a sound pressure level. In Table 1, F₀ can be an initial value of a resonance frequency and can be a frequency where a resonance peak initially appears in an audible frequency band. For example, F₀ can be a low sound reproduction band. For example, as a value of F₀ is reduced, the low sound reproduction band can be wide, and a speaker can be evaluated to be a good speaker.

TABLE 1

| Frequency | Sound | Experiment | | Embodiment | | Embodiment | |
|---|---|---|---|---|---|---|---|
| (Hz) | Performance | Example 1 | | 1 | | 2 | |
| 0.15 to | Average Sound | 88.78 | dB | 97.48 | dB | 90.71 | dB |
| 20 kHz | Pressure Level | | | | | | |
| | Standard | 6.69 | | 9.38 | | 8.11 | |
| | Deviation | | | | | | |
| | F₀ | 239 | Hz | 88 | Hz | 88 | Hz |

Referring to FIG. 17 and Table 1, the average sound pressure levels (SPL) (dB) of the experiment example 1, the embodiment 1, and the embodiment 2 respectively represent 88.78 dB, 97.48 dB, and 90.71 dB in 0.15 kHz to 20 kHz. Therefore, it can be seen that the embodiment 1 and the embodiment 2 represent sound pressure levels which are higher than that of the experiment example 1.

The average sound pressure level of the embodiment 1 has been measured to be about 8.7 dB higher than that of the experiment example 1. In the embodiment 1, because a vibration member includes a pattern part, the stiffness of the vibration member in a third direction (or a Z-axis direction) can maintain the stiffness of aluminum (Al), and the stiffness of the vibration member in a first direction (or an X-axis direction) and a second direction (or a Y-axis direction) can be relatively flexible. For example, the stiffness of the vibration member in an XY axis and the stiffness of the vibration member in a Z axis can be changed, and for example, bending stiffness can be changed. Accordingly, comparing with the experiment example 1, in the embodiment 1, it can be seen that a sound pressure level is enhanced, and a low sound reproduction band extends.

For example, in a case where a small vibration plate (or vibration member) is configured, a sound pressure level in the low sound reproduction band can be reduced. For example, in the small vibration member, a sound can be generated by a piston vibration where the vibration member moves upward and downward, in a low frequency, and a moving region can decrease as an area of the vibration member is reduced, whereby a sound pressure level in a low frequency can decrease. However, the vibration member should have a sound pressure level similar to a middle-high pitched sound band, so as to perform a speaker function in an audible frequency.

Therefore, in an embodiment of the present disclosure, because a pattern part is configured in a vibration member, a sound pressure level can be enhanced, and the low sound reproduction band can extend. Accordingly, an embodiment of the present disclosure can be applied to a small sound output apparatus. Also, comparing with the experiment example 1, in a middle-high pitched sound band of 1 kHz or more, an embodiment of the present disclosure can have a high sound pressure level, thereby providing a sound output apparatus which can function as a speaker in an audible frequency (for example, 20 Hz to 20 kHz).

The average sound pressure level of the embodiment 2 has been measured to be 1.93 dB higher than that of the experiment example 1 and has been measured to be 6.77 dB lower than that of the embodiment 1. In the embodiment 2, a low sound reproduction band has been measured to be similar to the embodiment 1, and comparing with the experiment example 1, because the adhesive member is additionally configured, it can be seen that the flatness of a sound pressure level is improved.

The standard deviations of the experiment example 1, the embodiment 1, and the embodiment 2 have been measured to respectively be 6.69, 9.38, and 8.11. Comparing with the experiment example 1, the standard deviations of the embodiment 1 and the embodiment 2 have respectively increased by 2.69 and 1.42. Accordingly, comparing with the experiment example 1, in the embodiment 2, it can be seen that the flatness of a sound pressure level is good.

F₀ of the experiment example 1, the embodiment 1, and the embodiment 2 have been measured to respectively be 239 Hz, 88 Hz, and 88 Hz. Comparing with the experiment example 1, F₀ of the embodiment 1 and the embodiment 2 have respectively reduced by 151 Hz. Accordingly, comparing with the experiment example 1, in the embodiment 1 and the embodiment 2, it can be seen that a low sound reproduction band extends.

The following Table 2 can be a table where physical properties of the vibration member of the experiment example 1 is compared with physical properties of the vibration member of the embodiment 1.

TABLE 2

| | Density | E [GPa] | | | Poisson's Ratio | | | Shear Modulus [GPa] | | |
|---|---|---|---|---|---|---|---|---|---|---|
| | [kg/m³] | X | Y | Z | XY | YZ | XZ | XY | YZ | XZ |
| Embodiment | 277 | 0.13 | 0.13 | 7.1 | 0.96 | 0.0062 | 0.0062 | 0.0035 | 1.40 | 1.40 |
| 1 | | | | | | | | | | |
| Experiment | 2770 | 71 | | | 0.33 | | | 27 | | |
| Example 1 | | | | | | | | | | |

Referring to Table 2, a density of the experiment example 1 has been measured to be 2,770 kg/m3, and a density of the embodiment 1 has been measured to be 277 kg/m3. Therefore, when the vibration member includes a pattern part, it can be seen that a density decreases by about 10 times.

A young's modulus E, a Poisson's ratio, and a shear modulus of the experiment example 1 have been measured to respectively be 71 GPa, 0.33, and 27 GPa regardless of a direction.

A young's modulus of the embodiment 1 has been measured to be 0.13 GPa in the first direction (or the X-axis direction), 0.13 GPa in the second direction (or the Y-axis direction), and 7.1 GPa in the third direction (or the Z-axis direction). Therefore, it can be seen that a young's modulus in the third direction (or the Z-axis direction) is high and a young's modulus in the first direction (or the X-axis direction) and the second direction (or the Y-axis direction) is low. Accordingly, it can be seen that the embodiment 1 has flexibility because stiffness in third direction (or the Z-axis direction) is relatively strong and stiffness in the first direction (or the X-axis direction) and the second direction (or the Y-axis direction) is relatively low.

A Poisson's ratio of the embodiment 1 has been measured to be 0.96 in an XY-axis direction, 0.0062 in a YZ-axis direction, and 0.0062 in an XZ-axis direction. For example, a Poisson's ratio can denote that a strain is low with respect to an external force as a Poisson's ratio decreases, and a strain increases as a Poisson's ratio increases. For example, in a vibration plate where a pattern part is not configured, the embodiment 1 can have the same Poisson's ratio with respect to an X axis, a Y axis, and a Z axis.

An embodiment of the present disclosure can include the pattern part, and thus, it can be seen that a Poisson's ratio is changed based on the pattern part. According to an embodiment of the present disclosure, a Poisson's ratio of the embodiment 1 having 0.96 in the XY-axis direction, 0.0062 in the YZ-axis direction, and 0.0062 in the XZ-axis direction can denote that a strain is large based on an external force in a plane (X, Y axis), and a strain is small based on an external force in a vertical direction (Z axis). According to an embodiment of the present disclosure, a vibration plate can be strained based on an external force in the plane (X, Y axis) and can maintain a rigid state where the vibration plate is not strained based on an external force in the vertical direction (Z axis). Accordingly, a sound pressure level can be improved by a vibration based on the contraction and/or expansion of the vibration plate in the plane (X, Y axis) (in-plane), and stiffness in the Z axis (out-of-plane) can be maintained, and thus, vibration transfer can be maximized, thereby extending a reproduction band of a low pitched sound band.

A shear modulus of the embodiment 1 has been measured to be 0.0035 in the XY-axis direction, 1.40 in the YZ-axis direction, and 1.40 in the XZ-axis direction. For example, a shear modulus can denote a modulus value in a shear direction. For example, in a vibration plate where a pattern part is not configured, a young's modulus can be equal to one another in all directions, and thus, a shear modulus can not be measured.

In an embodiment of the present disclosure, since the pattern part is configured, physical properties of a vibration plate in an XY axis, a YZ axis, and an XZ axis can be changed. For example, a vibration plate can be flexible in the XY-axis (or in-plane) direction and can have high elasticity in the Z-axis (or out-of-plane) direction. For example, a shear modulus which is a modulus appearing when stretching in the shear direction can differ from a young's modulus. Therefore, when stretching in the XY-axis direction, a shear modulus in the YZ axis can differ from a shear modulus in the XZ axis. For example, this can denote that the degree of strain based on an external force decreases as a shear modulus increases. According to an embodiment of the present disclosure, a shear modulus in the XY axis can be less than a shear modulus in the YZ axis and a shear modulus in the XZ axis, and thus, the degree of strain based on an external force can be large. Accordingly, a sound pressure level can be improved by a vibration based on the contraction and/or expansion of the vibration plate in the plane (XY axis) (in-plane), thereby extending a reproduction band of a low pitched sound band.

FIG. 18 is a graph showing a sound pressure level characteristic of a sound output apparatus according to an experiment example and an embodiment of the present disclosure.

The inventors have prepared an experiment example 2 and an embodiment 3 as samples, so as to compare a sound pressure level of the sound output apparatus according to an embodiment of the present disclosure. The experiment example 2 has prepared the sample by coupling the vibration apparatus to a vibration member which includes aluminum and where a pattern part is not formed. The embodiment 3 is the sound output apparatus according to an embodiment of the present disclosure described above with reference to FIGS. 2 and 3 and has prepared the sample by coupling the vibration apparatus to a vibration member where resin is filled in each of a plurality of holes. TPU has been used as the resin. For example, the resin can be filled in each of the plurality of holes by 85% or more. In the experiment example 2 and the embodiment 3, sizes of the vibration members have been identically prepared to have a width of 150 mm, a height of 60 mm, and a thickness of 0.3 mm. In the experiment example 2 and the embodiment 3, sizes of the vibration apparatuses have been identically prepared to a width of 120 mm, a height of 60 mm, and a thickness of 0.16 mm. In FIG. 18, the abscissa axis represents a frequency (Hz (hertz)), and the ordinate axis represents a sound pressure level (SPL) (dB (decibel)). In FIG. 18, a thin solid line and a thick solid line respectively represent the experiment example 2 and the embodiment 3. The vibration member of the embodiment 3 includes aluminum. An experiment condition of FIG. 18 does not limit the details of the present disclosure.

The following Table 3 can be a table which shows the sound performance of sound output apparatuses according to the experiment example 2 and the embodiment 3.

TABLE 3

| Frequency | Sound | Experiment | | Embodiment | |
|---|---|---|---|---|---|
| (Hz) | Performance | Example 2 | | 3 | |
| 0.15 to | Average Sound | 77.24 | dB | 88.72 | dB |
| 20 kHz | Pressure Level | | | | |
| | F₀ | 386 | Hz | 113 | Hz |

Referring to FIG. 18 and Table 3, the average sound pressure levels (SPL) (dB) of the experiment example 2 and the embodiment 3 with respect to a frequency represent 77.24 dB and 88.72 dB in 0.15 kHz to 20 kHz, respectively. Therefore, it can be seen that the embodiment 3 represents a sound pressure level which is higher than that of the experiment example 2.

The average sound pressure level of the embodiment 3 has been measured to be about 11.48 dB higher than that of the experiment example 2. In the embodiment 3, the stiffness of the vibration member in the third direction (or the Z-axis direction) can maintain the stiffness of aluminum (Al), and the stiffness of the vibration member in the first direction (or the X-axis direction) and the second direction (or the Y-axis direction) can be more reduced than the stiffness of the vibration member in the third direction (or the Z-axis direction). Accordingly, comparing with the experiment example 2, in the embodiment 3, it can be seen that a sound pressure level is enhanced, and a low sound reproduction band extends.

F₀ of the experiment example 2 and the embodiment 3 have been measured to respectively be 386 Hz and 113 Hz. Comparing with the experiment example 2, F₀ of the embodiment 3 has decreased by 273 Hz. Accordingly, comparing with the experiment example 2, in the embodiment 3, it can be seen that a low sound reproduction band extends.

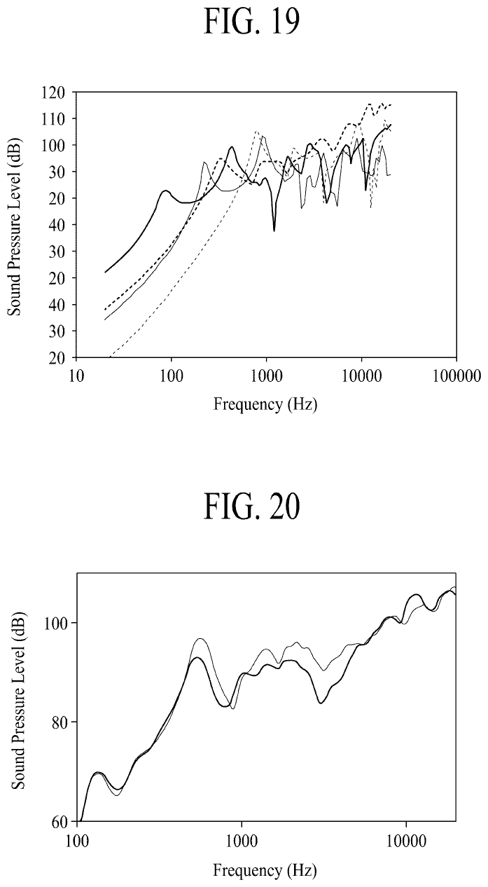

FIG. 19 is a graph showing a sound pressure level characteristic with respect to a frequency based on a size of a vibration member according to experiment examples and embodiments of the present disclosure.

The inventors have prepared an experiment example 1, an experiment example 3, an embodiment 2, and an embodiment 4 as samples, so as to compare a sound pressure level of a sound output apparatus with respect to a size of a vibration member. The experiment example 1 and the embodiment 2 have prepared samples like the experiment example 1 and the embodiment 2 described above with reference to FIG. 17. In the experiment example 1 and the embodiment 2, sizes of the vibration members have been identically prepared to have a width of 200 mm, a height of 200 mm, and a thickness of 0.1 mm. The experiment example 3 and the embodiment 4 have prepared samples under the same condition as the experiment example 1 and the embodiment 2. In the experiment example 3 and the embodiment 4, sizes of the vibration members have been prepared to have a width of 150 mm and a height of 100 mm. In the experiment example 3 and the embodiment 4, thicknesses of the vibration members have been prepared to be 0.1 mm and 0.5 mm. In the embodiment 4, a thickness of each of a vibration plate, first and second protection members, and first and second adhesive members is 0.1 mm. In FIG. 19, the abscissa axis represents a frequency (Hz (hertz)), and the ordinate axis represents a sound pressure level (SPL) (dB (decibel)). In FIG. 19, a thin solid line, a thin dotted line, a thick solid line, and a thick dotted line respectively represent the experiment example 1, the experiment example 3, the embodiment 2, and the embodiment 4. The vibration members of the experiment example 1, the experiment example 3, the embodiment 2, and the embodiment 4 include aluminum. An experiment condition of FIG. 19 does not limit the details of the present disclosure.

The following Table 4 can be a table which shows the sound performance of sound output apparatuses according to the experiment example 1, the experiment example 3, the embodiment 2, and the embodiment 4.

TABLE 4

| | | | | Embodi- | Embodi- |
|---|---|---|---|---|---|
| Frequency | Sound | Experiment | Experiment | ment | ment |
| (Hz) | Performance | Example 1 | Example 3 | 2 | 4 |
| 0.15 to | Average | 88.78 | 84.81 | 90.71 | 91.89 |
| 20 kHz | Sound | | | | |
| | Pressure Level | | | | |
| | F₀ | 239 Hz | 747 Hz | 88 Hz | 312 Hz |

Referring to FIG. 19 and Table 4, the average sound pressure levels (SPL) (dB) of the experiment example 1 and the experiment example 3 respectively represent 88.78 dB and 84.81 dB in 0.15 kHz to 20 kHz. F₀ of the experiment example 1 and the experiment example 3 have been measured to be 239 Hz and 747 Hz. Comparing with the experiment example 1, F₀ of the experiment example 3 has increased by 508 Hz. Therefore, when a vibration member does not include a pattern part, the inventors can confirm that an average sound pressure level decreases as a size of the vibration member is reduced.

The average sound pressure levels (SPL) (dB) of the embodiment 2 and the embodiment 4 respectively represent 90.71 dB and 91.89 dB in 0.15 kHz to 20 kHz. Comparing with the embodiment 2, the average sound pressure level of the embodiment 4 has increased by about 1.18 dB. The standard deviations of the embodiment 2 and the embodiment 4 have been measured to be 8.11 and 9.94. Comparing with the embodiment 2, the standard deviation of the embodiment 4 has increased by 1.83. Accordingly, when a vibration member includes a pattern part, the inventors can confirm that an average sound pressure level is enhanced despite a reduction in size of the vibration member.

F₀ of the embodiment 2 and the embodiment 4 have been measured to respectively be 88 Hz and 312 Hz. Therefore, comparing with the experiment examples, in embodiments of the present disclosure, it can be seen that a low sound reproduction band can extend. Also, comparing with the experiment example 1 and the experiment example 3, in the embodiment 2 and the embodiment 4, it can be seen that a sound pressure level can be enhanced, and the low sound reproduction band can extend. Accordingly, a sound output apparatus according to an embodiment of the present disclosure can be applied to a small sound output apparatus without a reduction in sound quality characteristic and/or sound pressure level characteristic of a sound.

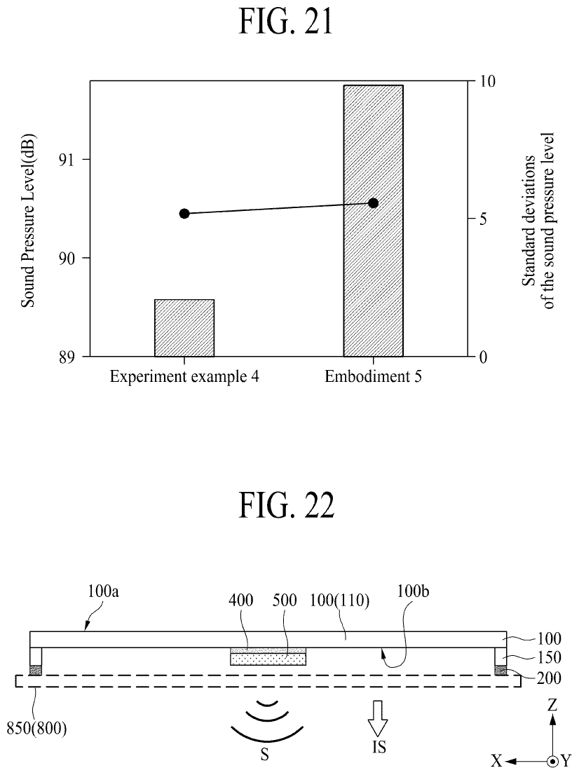

FIG. 20 is a graph showing a sound pressure level characteristic according to an experiment example and another embodiment of the present disclosure. FIG. 21 is a graph showing an average sound pressure level and a standard deviation according to an experiment example and another embodiment of the present disclosure. This relates to a sound output apparatus to which the vibration member according to another embodiment of the present disclosure described above with reference to FIGS. 5 and 6 is applied.

To compare with a sound pressure level of the sound output apparatus according to another embodiment of the present disclosure, the inventors have prepared an experiment example 4 and an embodiment 5 as samples. The experiment example 4 has prepared the sample by coupling a vibration apparatus to a vibration member including plastic where a pattern part is not formed. The embodiment 5 is the sound output apparatus according to another embodiment of the present disclosure described above with reference to FIGS. 5 and 6 and has prepared the sample by coupling the vibration apparatus to a vibration member where a second pattern part is configured in a third region of a vibration plate. A vibration plate of the embodiment 5 has been prepared by using a three-dimensional (3D) printing process. A vibration member of the experiment example 4 and a vibration member of the embodiment 5 include an ABS material. In the experiment example 4 and the embodiment 5, sizes of the vibration members have been prepared to have a width of 120 mm and a height of 60 mm. In the experiment example 4, a thickness of the vibration member has been prepared to be 2 mm, and in the embodiment 5, a thickness of the vibration member has been prepared to be 3 mm in a first region and 2 mm in a third region. In FIG. 20, the abscissa axis represents a frequency (Hz (hertz)), and the ordinate axis represents a sound pressure level (SPL) (dB (decibel)). In FIG. 20, a thin solid line and a thick solid line respectively represent the experiment example 4 and the embodiment 5. In FIG. 21, a bar graph shows an average sound pressure level, and a broken-line graph shows a standard deviation of a sound pressure level. An experiment condition of FIGS. 20 and 21 does not limit the details of the present disclosure.

Referring to FIGS. 20 and 21, average sound pressure levels of the experiment example 4 and the embodiment 5 have been measured to respectively be 89.6 dB and 91.8 dB. The average sound pressure level of the embodiment 5 has been measured to be about 2.2 dB higher than the average sound pressure level of the experiment example 4. Standard deviations of the average sound pressure levels of the experiment example 4 and the embodiment 5 have been similarly measured to be about 5.2 and about 5.6.

Therefore, according to an embodiment of the present disclosure, when a vibration member includes a pattern part, it can be seen that an average sound pressure level of a sound output apparatus is improved. Also, when the vibration member includes a plastic material, it can be seen that a sound pressure level characteristic is more enhanced in a pitched sound band including a low pitched sound band.

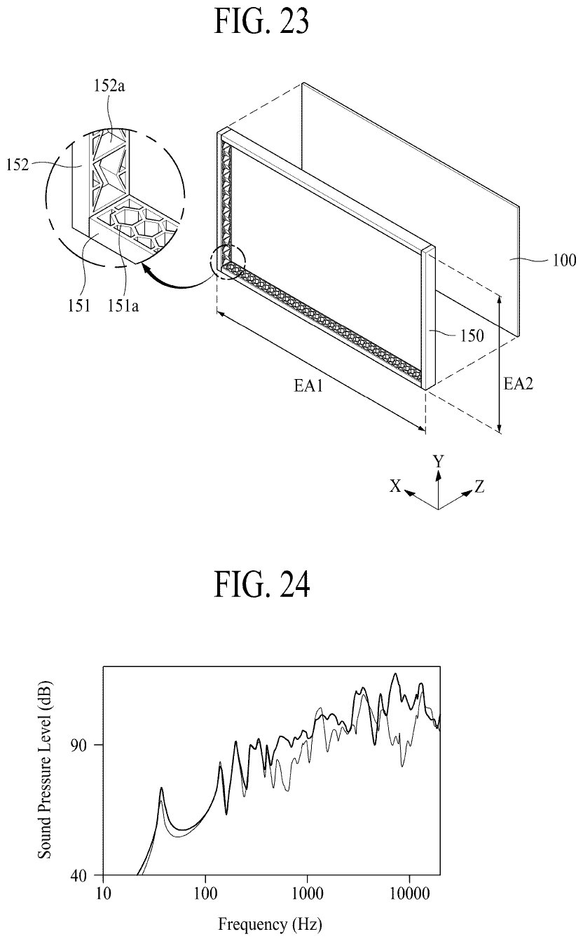

FIG. 22 is a cross-sectional view illustrating a vehicular sound apparatus according to an embodiment of the present disclosure. FIG. 23 is an exploded perspective view of a sound output apparatus illustrated in FIG. 22 according to an embodiment of the present disclosure.

Referring to FIG. 22, a vehicular sound apparatus according to an embodiment of the present disclosure can include a sound output apparatus as describe above. The sound output apparatus can be disposed or equipped in a vehicle so as to output a sound S toward an internal space IS of a vehicle 800.

The vehicle 800 can include an interior material (or an interior finish material) 850. In the following description, for convenience of description, the “interior material 850” can be referred to as a “vehicular interior material 850”.

The vehicular interior material 850 can include all parts configuring the inside of the vehicle 800, or can include all parts disposed at the internal space IS of the vehicle 800. For example, the vehicular interior material 850 can be an interior member or an inner finishing member of the vehicle 800, but embodiments of the present disclosure are not limited thereto. For example, the vehicular interior material 850 can be a supporting member configured to support the sound output apparatus, through which vibration is transmitted by the sound output apparatus.

The vehicular interior material 850 according to an embodiment of the present disclosure can be configured to be exposed at the internal or indoor space IS of the vehicle 800, in the internal or indoor space IS of the vehicle 800. For example, the vehicular interior material 850 can be provided to cover one surface (or an interior surface) of at least one of a main frame (or a vehicular body), a side frame (or a side body), a door frame (or a door body), a handle frame (or a steering hub), and a seat frame, which are exposed at the indoor space IS of the vehicle 800.

The vehicular interior material 850 according to an embodiment of the present disclosure can include a dash board, a pillar interior material (or a pillar trim), a floor interior material (or a floor carpet), a roof interior material (or a headliner), a door interior material (or a door trim), a handle interior material (or a steering cover), a seat interior material, a rear package interior material (or a backseat shelf), an overhead console (or an indoor illumination interior material), a rear view mirror, a glove box, and a sun visor, but embodiments of the present disclosure are not limited thereto.

The vehicular interior material 850 according to an embodiment of the present disclosure can include one or more of metal, wood, rubber, plastic, glass, fiber, cloth, paper, mirror, leather, and carbon, but embodiments of the present disclosure are not limited thereto. The vehicular interior material 850 including a plastic material can be an injection material which is implemented by an injection process using thermosetting resin or thermoplastic resin, but embodiments of the present disclosure are not limited thereto. The vehicular interior material 850 including a fiber material can include one or more of synthetic fiber, carbon fiber (or aramid fiber), and natural fiber, but embodiments of the present disclosure are not limited thereto. The vehicular interior material 850 including a fiber material can be a fabric sheet, a knitting sheet, or a nonwoven fabric, but embodiments of the present disclosure are not limited thereto. For example, the paper can be cone paper. For example, the cone paper can be pulp or foam plastic, but embodiments of the present disclosure are not limited thereto. The vehicular interior material 850 including a leather material can be a natural leather or an artificial leather, but embodiments of the present disclosure are not limited thereto.

The vehicular interior material 850 according to an embodiment of the present disclosure can include one or more of a flat portion and a curved portion. For example, the vehicular interior material 850 can have a structure corresponding to a structure of a corresponding vehicular structure material, or can have a structure which differs from the structure of the corresponding vehicular structure material.

According to an embodiment of the present disclosure, the vibration member 100 can be connected to a vehicular interior material 850. The vibration member 100 can be connected to the vehicular interior material 850 by using the coupling member 200 and the vibration transfer member 150. According to an embodiment of the present disclosure, the vibration member 100 can include one of the vibration member 100 and the vibration plate 110 described above with reference to FIGS. 3 to 10. A vibration apparatus 500 can be configured at a second surface 100b of the vibration member 100 facing the vehicular interior material 850.

According to an embodiment of the present disclosure, the vibration apparatus 500 can be configured on the vibration member 100. The vibration apparatus 500 can vibrate the vibration member 100 to transfer a vibration to the vehicular interior material 850 connected to the vibration member 100. The vibration apparatus 500 can generate a sound S, based on the vibration transferred to the vehicular interior material 850. For example, the vibration apparatus 500 can indirectly vibrate the vehicular interior material 850 by using the vibration member 100 and the vibration transfer member 150 to generate the sound S, based on the vibration of the vehicular interior material 850.

For example, the vibration apparatus 500 can be configured as the vibration apparatus according to an embodiment of the present disclosure described above with reference to FIGS. 11 to 16.

For example, the vibration apparatus 500 can be configured to vibrate the vehicular interior material 850 to output the sound S toward an inner portion or an indoor space IS of a vehicle 800, based on the vibration member 100 and the vibration transfer member 150. For example, the vehicular interior material 850 can have a size which is greater than that of the vibration apparatus 500, but embodiments of the present disclosure are not limited thereto.

The vibration transfer member 150 can be configured between the vehicular interior material 850 and the vibration member 100. The vibration transfer member 150 can be coupled to the vehicular interior material 850 by using the coupling member 200.

The vibration transfer member 150 can be configured in an edge region of the vibration member 100. The vibration transfer member 150 can include a polygonal shape including a rectangular shape or a square shape, based on a shape of the vibration member 100, but embodiments of the present disclosure are not limited thereto. For example, the vibration transfer member 150 can have a horizontal length parallel to a first direction X and a vertical length parallel to a second direction Y. For example, with respect to the same plane, the first direction X can be a first horizontal direction or a first horizontal length direction of the vibration transfer member 150, and the second direction Y can be a second horizontal direction crossing the first direction X or a second horizontal length direction of the vibration transfer member 150. For example, a horizontal length parallel to the first direction X of the vibration transfer member 150 according to another embodiment of the present disclosure can differ from a vertical length parallel to the second direction Y. For example, the vibration transfer member 150 can include a frame structure having totally the same thickness, but embodiments of the present disclosure are not limited thereto.

According to an embodiment of the present disclosure, the vibration transfer member 150 can include a first vibration transfer member 151 and a second vibration transfer member 152.

The first vibration transfer member 151 can be connected to an edge portion of the vibration member 100 in parallel to a horizontal direction of the vibration member 100. The first vibration transfer member 151 can include a first auxiliary pattern part 151a. For example, the first vibration transfer member 151 can be connected to each of first and second edge portions EA1 of the vibration member 100 parallel to the horizontal direction of the vibration member 100. For example, the first auxiliary pattern part 151a can include a pattern part having a positive Poisson's ratio. For example, a positive Poisson's ratio pattern part can be a pattern part which is formed through contraction in a vertical direction when a tension stress is applied. The first auxiliary pattern part 151a can correspond to a long-axis direction of the vibration member 100. For example, an internal angle of the positive Poisson's ratio pattern part configured in the first auxiliary pattern part 151a can be 100 degrees or less. For example, the first auxiliary pattern part 151a can have a honeycomb structure.

The second vibration transfer member 152 can be connected to an edge portion of the vibration member 100 in parallel to a vertical direction of the vibration member 100. The second vibration transfer member 152 can include a second auxiliary pattern part 152a. For example, the second vibration transfer member 152 can be connected to each of third and fourth edge portions EA2 of the vibration member 100 parallel to the vertical direction of the vibration member 100. For example, the second auxiliary pattern part 152a can include a pattern part having a negative Poisson's ratio. For example, a negative Poisson's ratio pattern part can be a pattern part which is formed through expansion in the vertical direction when a tension stress is applied. The second auxiliary pattern part 152a can correspond to a short-axis direction of the vibration member 100. For example, an internal angle of the negative Poisson's ratio pattern part configured in the second auxiliary pattern part 152a can be 100 degrees or more. For example, the second auxiliary pattern part 152a can have an auxetic structure.

For example, the vibration transfer member 150 can be manufactured by using a laser process, a chemical etching process, or a computer numerical control (CNC) process, but embodiments of the present disclosure are not limited thereto.

According to another embodiment of the present disclosure, the vibration transfer member 150 can be configured as a bonding portion between the vehicular interior material 850 and a vehicular exterior material. For example, the first auxiliary pattern part 151a and the second auxiliary pattern part 152a can be configured in an entire region of the bonding portion between the vehicular interior material 850 and the vehicular exterior material. However, embodiments of the present disclosure are not limited thereto. As another example, the vibration transfer member 150 can be configured to include one of the first auxiliary pattern part 151a and the second auxiliary pattern part 152a. For example, a plurality of holes configured in each of the first auxiliary pattern part 151a and the second auxiliary pattern part 152a can be designed based on the density, flexure, and stiffness of the vibration member 100. For example, the XY-axis stiffness and the Z-axis stiffness of the vibration member 100 (for example, bending stiffness) can be changed.

According to an embodiment of the present disclosure, the vibration transfer member 150 including the first auxiliary pattern part 151a and the second auxiliary pattern part 152a can be configured between the vibration member 100 and the vehicular interior material 850, thereby maximizing a vibration generated in the vibration apparatus 500. Also, according to an embodiment of the present disclosure, because the vibration transfer member 150 includes the first auxiliary pattern part 151a and the second auxiliary pattern part 152a, a weight of a vehicular sound apparatus can be reduced compared to a case where an auxiliary pattern part is not configured. Accordingly, the lightness of a vehicular sound apparatus can be possible.

FIG. 24 is a graph showing a sound pressure level characteristic of the vehicular sound apparatus illustrated in FIG. 22 according to an experiment example and an embodiment of the present disclosure.

The inventors have prepared an experiment example 5 and an embodiment 6 as samples, so as to compare a sound pressure level of the vehicular sound apparatus according to an embodiment of the present disclosure. The experiment example 5 and the embodiment 6 have prepared the samples by coupling the vibration apparatus to a vibration member which includes aluminum and where a pattern part is not configured. The experiment example 5 has configured a member having a frame shape where first and second auxiliary pattern parts are not configured between a vibration member and a supporting member. The embodiment 6 has configured a member where first and second auxiliary pattern parts are configured between a vibration member and a supporting member. In the experiment example 5 and the embodiment 6, sizes of the vibration members have been identically prepared to have a width of 200 mm, a height of 200 mm, and a thickness of 0.1 mm. In the experiment example 5 and the embodiment 6, sizes of the vibration apparatuses have been identically prepared to a width of 120 mm, a height of 60 mm, and a thickness of 0.16 mm. In FIG. 24, the abscissa axis represents a frequency (Hz (hertz)), and the ordinate axis represents a sound pressure level (SPL) (dB (decibel)). In FIG. 24, a thin solid line and a thick solid line respectively represent the experiment example 5 and the embodiment 6. An experiment condition of FIG. 24 does not limit the details of the present disclosure.

The following Table 5 can be a table which shows the sound performance of sound apparatuses according to the experiment example 5 and the embodiment 6.

TABLE 5

| Frequency | Sound | Experiment | Embodiment |
|---|---|---|---|
| (Hz) | Performance | Example 5 | 6 |
| 0.15 to | Average Sound | 91.0 | 96.9 |
| 20 kHz | Pressure Level | | |

Referring to FIG. 24 and Table 5, the average sound pressure levels (SPL) (dB) of the experiment example 5 and the embodiment 6 respectively represent 91.0 dB and 96.9 dB in 0.15 kHz to 20 kHz. Comparing with the experiment example 5, the average sound pressure level of the embodiment 6 has increased by about 5.9 dB. Therefore, according to an embodiment of the present disclosure, when an auxiliary pattern part is configured between a vibration member and a supporting member, it can be seen that an average sound pressure level increases. According to an embodiment of the present disclosure, a vibration transfer member including auxiliary pattern parts having a positive Poisson's ratio and a negative Poisson's ratio can be configured, and thus, a vibration generated in the vibration member can be more efficiently transferred to the supporting member.

An apparatus according to one or more example embodiment of the present disclosure is described below.

A sound output apparatus according to one or more embodiment of the present disclosure can comprise a vibration member including a vibration plate, the vibration plate including a pattern part, and a vibration apparatus configured to vibrate the vibration member based on piezoelectric effect. The pattern part can comprise one or more of a plurality of holes and a plurality of grooves and is configured to increase an average sound pressure level of the sound output apparatus.

According to one or more embodiment of the present disclosure, the vibration plate can have a honeycomb structure, based on the plurality of holes.

According to one or more embodiment of the present disclosure, the vibration plate can comprise a first region, a second region surrounding the first region, and a third region between the first region and the second region, and the pattern part can be configured in the third region.

According to one or more embodiment of the present disclosure, the vibration plate can comprise a first region, a second region surrounding the first region, and a third region between the first region and the second region. The pattern part can comprise a pattern part configured in the first region and including the plurality of holes, and a pattern part configured in the third region and including the plurality of grooves.

According to one or more embodiment of the present disclosure, the pattern part configured in the first region has a honeycomb structure, based on the plurality of holes.

According to one or more embodiment of the present disclosure, the vibration plate can comprise a protrusion portion in the first region, the pattern part configured in the third region can comprise a plurality of protrusion patterns protruding from a lateral surface of the protrusion portion to the third region, and each of the plurality of grooves can be between the plurality of protrusion patterns.

According to one or more embodiment of the present disclosure, a height of each of the plurality of protrusion patterns can decrease progressively toward the second region from the first region.

According to one or more embodiment of the present disclosure, the vibration member can further comprise a first protection member configured at a first surface of the vibration plate, and a second protection member configured at a second surface, which is opposite to the first surface, of the vibration plate. The vibration apparatus can be connected to one of the first protection member and the second protection member.

According to one or more embodiment of the present disclosure, the vibration member can further comprise a first adhesive member configured between the first surface of the vibration plate and the first protection member, and a second adhesive member configured between the second surface of the vibration plate and the second protection member.

According to one or more embodiment of the present disclosure, wherein each of the plurality of holes and/or each of the plurality of grooves can be an empty space, or can be filled by resin.

According to one or more embodiment of the present disclosure, the pattern part can be configured at a front surface or a rear surface of the vibration plate, or through the vibration plate.

According to one or more embodiment of the present disclosure, the third region can have a thickness which is within a range of 30% to 35% of that of the first region and the same as that of the second region.

A sound apparatus according to one or more embodiment of the present disclosure can comprise a sound output apparatus as described above, a supporting member disposed to face the vibration member of the sound output apparatus, and a coupling member for connecting or coupling the supporting member to the vibration member.

According to one or more embodiment of the present disclosure, the sound apparatus can further comprise a vibration transfer member between the supporting member and the vibration member, the vibration transfer member coupled to the supporting member by using the coupling member. The vibration transfer member can comprise a first auxiliary pattern part and a second auxiliary pattern part differing from the first auxiliary pattern part.

According to one or more embodiment of the present disclosure, the vibration transfer member can comprise a first vibration transfer member connected to an edge portion of the vibration member in parallel to a horizontal direction of the vibration member, the first vibration transfer member including the first auxiliary pattern part, and a second vibration transfer member connected to an edge portion of the vibration member in parallel to a vertical direction of the vibration member, the second vibration transfer member including the second auxiliary pattern part.

According to one or more embodiment of the present disclosure, the first vibration transfer member can be connected to each of first and second edge portions of the vibration member parallel to the horizontal direction of the vibration member, and the second vibration transfer member can be connected to each of third and fourth edge portions of the vibration member parallel to the vertical direction of the vibration member.

According to one or more embodiment of the present disclosure, a Poisson's ratio of the first auxiliary pattern part can be different from or opposite to a Poisson's ratio of the second auxiliary pattern part.

According to one or more embodiment of the present disclosure, the first auxiliary pattern part can have a positive Poisson's ratio, and the second auxiliary pattern part can have a negative Poisson's ratio.

According to one or more embodiment of the present disclosure, the first auxiliary pattern part can have a honeycomb structure, and the second auxiliary pattern part can have an auxetic structure.

According to one or more embodiment of the present disclosure, the supporting member can be configured to support a periphery portion of the vibration member so as to cover the vibration apparatus of the sound output apparatus.

According to one or more embodiment of the present disclosure, the supporting member can be a vehicular interior material.

According to one or more embodiment of the present disclosure, the sound output apparatus can further comprise a resin accommodated into one or more of the plurality of holes or the plurality of grooves.

According to one or more embodiment of the present disclosure, the vibration apparatus can comprise a first cover member, a second cover member, and a vibration part between the first cover member and the second cover member, the vibration part including a piezoelectric material.

According to one or more embodiment of the present disclosure, the vibration apparatus can further comprise a signal supply member electrically connected to the vibration part, and a portion of the signal supply member can be accommodated between the first cover member and the second cover member.

According to one or more embodiment of the present disclosure, the vibration apparatus can comprise a first vibration generating part, a second vibration generating part stacked on the first vibration generating part, and a middle member between the first vibration generating part and the second vibration generating part. One of the first vibration generating part and the second vibration generating part can be connected to the vibration plate.

According to one or more embodiment of the present disclosure, each of the first and second vibration generating parts can comprise a first cover member, a second cover member, and a vibration part between the first cover member and the second cover member, the vibration part including a piezoelectric material.

It will be apparent to those skilled in the art that various modifications and variations can be made in the present disclosure without departing from the spirit or scope of the disclosures. Thus, it is intended that the present disclosure covers the modifications and variations of this disclosure and their equivalents.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A sound output apparatus comprising:
a vibration member including a vibration plate, the vibration plate including a pattern; and
a vibration apparatus configured to vibrate the vibration member via a piezoelectric effect,
wherein the pattern comprises at least one of a plurality of holes and a plurality of grooves, and the pattern is configured to increase an average sound pressure level of the sound output apparatus.

2. The sound output apparatus of claim 1, wherein the pattern of the vibration plate includes the plurality of holes in a honeycomb structure.

3. The sound output apparatus of claim 1, wherein the vibration plate comprises a first region, a second region surrounding the first region, and a third region between the first region and the second region, and
the pattern is in the third region.

4. The sound output apparatus of claim 1, wherein the vibration plate comprises a first region, a second region surrounding the first region, and a third region between the first region and the second region, and
the pattern comprises:
a first pattern in the first region and including the plurality of holes; and
a second pattern in the third region and including the plurality of grooves.

5. The sound output apparatus of claim 4, wherein the pattern in the first region has the plurality of holes in a honeycomb structure.

6. The sound output apparatus of claim 3, wherein the vibration plate comprises a protrusion portion in the first region,
the pattern in the third region comprises a plurality of protrusions protruding from a lateral surface of the protrusion portion to the third region, and
each of the plurality of grooves is between the plurality of protrusions.

7. The sound output apparatus of claim 6, wherein a height of each of the plurality of protrusions decreases progressively from the first region toward the second region.

8. The sound output apparatus of claim 2, wherein the vibration member further comprises:
a first protection member at a first surface of the vibration plate; and
a second protection member at a second surface of the vibration plate, the second surface opposite to the first surface of the vibration plate,
wherein the vibration apparatus is connected to one of the first protection member and the second protection member.

9. The sound output apparatus of claim 8, wherein the vibration member further comprises:
a first adhesive member between the first surface of the vibration plate and the first protection member; and
a second adhesive member between the second surface of the vibration plate and the second protection member.

10. The sound output apparatus of claim 1, wherein each of the plurality of holes or each of the plurality of grooves, or both, is an empty space or is filled by resin.

11. The sound output apparatus of claim 1, wherein the pattern is at a front surface or a rear surface of the vibration plate, or through the vibration plate.

12. The sound output apparatus of claim 3, wherein the third region has a thickness in a range of 30% to 35% of a thickness of the first region and the thickness of the third region is the same as a thickness of the second region.

13. A sound apparatus comprising:
a vibration member including a patterned vibration plate, wherein the pattern of the vibration plate comprises a plurality of openings configured to increase an average sound pressure level of the sound output apparatus;
a vibration apparatus configured to vibrate the vibration member via a piezoelectric effect;
a supporting member facing the vibration member; and
a coupling member coupling the supporting member to the vibration member.

14. The sound apparatus of claim 13, further comprising:
a vibration transfer member between the supporting member and the vibration member, the vibration transfer member coupled to the supporting member via the coupling member,
wherein the vibration transfer member comprises a first auxiliary pattern and a second auxiliary pattern differing from the first auxiliary pattern.

15. The sound apparatus of claim 14, wherein the vibration transfer member comprises:
a first vibration transfer member connected to an edge portion of the vibration member in parallel to a horizontal direction of the vibration member, the first vibration transfer member including the first auxiliary pattern; and
a second vibration transfer member connected to an edge portion of the vibration member in parallel to a vertical direction of the vibration member, the second vibration transfer member including the second auxiliary pattern.

16. The sound apparatus of claim 14, wherein the first vibration transfer member is connected to each of first and second edge portions of the vibration member parallel to the horizontal direction of the vibration member, and
the second vibration transfer member is connected to each of third and fourth edge portions of the vibration member parallel to the vertical direction of the vibration member.

17. The sound apparatus of claim 15, wherein a Poisson's ratio of the first auxiliary pattern is different from or opposite to a Poisson's ratio of the second auxiliary pattern.

18. The sound apparatus of claim 15, wherein the first auxiliary pattern has a honeycomb structure, and
the second auxiliary pattern has an auxetic structure.

19. The sound apparatus of claim 13, wherein the supporting member is configured to support a periphery portion of the vibration member so as to cover the vibration apparatus of the sound output apparatus.

20. The sound apparatus of claim 13, wherein the supporting member is a vehicular interior material.
